(19) United States
(12) Patent Application Publication
(10) Pub. No.: US 2005/0154118 A1
(43) Pub. Date: Jul. 14, 2005

(54) Polyester composition comprising carbon black

(76) Inventors: Richard Allen Hayes, Brentwood, TN (US); Steven M. Hansen, Vienna, WV (US); Kenneth B. Atwood, Hendersonville, TN (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/032,641

(22) Filed: Jan. 10, 2005

Related U.S. Application Data
(60) Provisional application No. 60/535,340, filed on Jan. 9, 2004.

(51) Int. Cl. C08K 3/04

(52) U.S. Cl. 524/495

(57) ABSTRACT

This invention provides certain processes to produce polyester compositions, which incorporate certain carbon black materials. This invention further provides the polyester products produced and shaped articles formed therefrom. The processes allows for the lowest levels of certain carbon blacks while maintaining the desired product attributes, such as electrical properties. The low levels of carbon black incorporated further provides production, processing, and end use benefits through a lower product melt viscosity.

The invention claims the priority to U.S. provisional application 60/535,340, filed Jan. 9, 2004, entire disclosure of which is incorporated herein by reference.

The invention relates to a method for producing polyester containing carbon black and shaped articles produced therefrom.

### BACKGROUND OF THE INVENTION

Carbon black filled polymers are typically classified within the art through their electrical characteristics into three categories: antistatic, static dissipating or moderately conductive, and conductive. See, e.g., U.S. Pat. No. 6,540,945 and U.S. Pat. No. 6,545,081.

Electrically conductive polyester compositions within the art typically have high carbon black loadings which typically diminishes other desired properties. For example, JP 61000256 A2 discloses conductive polyester compositions with a 25 weight percent carbon black level. See also the following patents or patent applications U.S. Pat. No. 3,803,453; U.S. Pat. No. 4,351,745; U.S. Pat. No. 4,559,164; U.S. Pat. No. 4,610,925; U.S. Pat. No. 5,262,470; U.S. Pat. No. 5,484,838; U.S. Pat. No. 5,643,991; U.S. Pat. No. 5,698,148; U.S. Pat. No. 5,776,608; U.S. Pat. No. 5,952,099; U.S. Pat. No. 5,726,283; U.S. Pat. No. 5,916,506; U.S. Pat. No. 6,242,094; U.S. Pat. No. 6,096,818; U.S. Pat. No. 6,291,567; U.S. Pat. No. 6,139,943; U.S. Pat. No. 6,174,427; U.S. Pat. No. 6,331,586; JP01022367; JP61000256; JP3327426 B2; and EP1277807.

On the other hand, the reduction of the carbon black loading does not result in the desired electrical properties. For example, JP 50133243 discloses that the incorporation of 0.4 weight percent of carbon black into a polyester film through a polymerization process resulted in an electrical resistance of 8,000,000,000,000 Ohms/square.

Carbon black, which is generally difficult to disperse into the polyester matrix, enhances the melt viscosity of the carbon black-filled polyester composition. Within the typical art extrusion compounding processes for the production of such materials, the compositions tend to be overworked at high shear and temperature conditions, causing the resins to degrade and lose a portion of their valued physical and thermal properties. The high melt viscosity of these carbon black-filled polyester resins further complicates production processes to produce useful shaped articles, such as monofilaments, textile fibers, films, sheets, molded parts, and the like. The shaped articles produced from such carbon black-filled polyester further suffers from deteriorated properties such as physically brittle. See, for example, U.S. Pat. No. 3,969,559; U.S. Pat. No. 4,255,487; U.S. Pat. No. 5,952,099; U.S. Pat. No. 6,037,395; U.S. Pat. No. 6,139,943; U.S. Pat. No. 6,331,586; and U.S. Pat. No. 6,331,586.

Carbon black has been incorporated into polyester. See, e.g., JP45023029, JP48056251, JP48056252, JP49087792, JP50037849, JP51029898, JP51029899, JP55066922, JP57041502, JP58030414, JP02043764, JP08026137, and JP59071357. See also, DE10118704; U.S. Pat. No. 3,275,590; U.S. Pat. No. 4,408,004; U.S. Pat. No. 4,476,272; U.S. Pat. No. 4,535,118; U.S. Pat. No. 5,925,710 and U.S. Pat. No. 6,503,586. None of these disclosures were concerned with conductive polyester compositions or utilized the carbon blacks disclosed in the present invention.

Deagglomeration of carbon black particles through intensive mixing processes and the use of the obtain carbon black dispersions in polyester is known. For example, GB1000101 discloses using carbon blacks with surface areas (as determined by the nitrogen adsorption method) in the range of 75 to 280 m²/g. See also, U.S. Pat. No. 3,790,653; U.S. Pat. No. 3,830,773; U.S. Pat. No. 3,905,938; U.S. Pat. No. 4,546,036; U.S. Pat. No. 4,603,073 and U.S. Pat. No. 5,143,650. However, use of deagglomeration of highly conductive carbon black fillers have not been disclosed.

The present invention overcomes these shortcomings of the art and provides a process to produce and the polyester compositions produced thereby which have the desired electrical properties without unduly deteriorating the other valued melt viscosity, processing, and shaped article properties. Said polyester compositions have the lowest carbon black loading levels heretofore seen within the art.

### BRIEF SUMMARY OF THE INVENTION

The invention provides a method comprising contacting a first composition with a second composition under a condition effective to produce a polyester and optionally recovering the polyester wherein the first composition comprises at least one dicarboxylic acid, or at least one oligomer of the acid; the second composition comprises at least one glycol; the first composition, the second composition, or both optionally comprises at least one carbon black and optionally an additive including filler or blend of polymers; the mole ratio of glycol to dicarboxylic acid ranges from about 0.9:1 to about 1.1:1; the carbon black is present in less than 15 weight % of the total weight of the polyester and the carbon black or less than 9 weight % of the total weight of the dicarboxylic acid, glycol, and carbon black; the carbon black has a dibutyl phthalate oil adsorption either greater than 420 cc/100 g, between 220 cc/100 g and 420 cc/100 g, between 150 cc/100 g and 210 cc/100 g, or combinations of two or more thereof wherein the dibutyl phthalate oil adsorption is determined by ASTM D2414-93; and the carbon black optionally has a nitrogen adsorption surface area by ASTM D 3037-81 greater than 700 m²/g.

### DETAILED DESCRIPTION OF THE INVENTION

The conductive carbon black fillers is defined by their structure, as defined by dibutyl phthlate, (DBP), absorption. Dibutyl phthalate absorption is measured according to ASTM Method Number D2414-93. High structure carbon blacks typically also have high surface areas. The surface areas of carbon blacks may be measured by ASTM Method Number D3037-81. This method measures the nitrogen adsorption, (BET), of the carbon black.

The invention includes processes to produce polyester compositions with the desired properties, such as electrical properties, which incorporate equal to or less than about 4.5 weight percent of carbon blacks having a DBP greater than about 420 cc/100 g, the products produced thereby, and shaped articles formed from said products. The polyester compositions incorporate from about 0.5 to about 4, or 1 to 3.5, weight % of carbon blacks having a DBP greater than about 420 cc/100 g.

The polyesters have repeat units derived from a dicarboxylic acid, a glycol, and, optionally, a polyfunctional branching agent component.

The first composition can comprise at least one dicarboxylic acid or an oligomer thereof including unsubstituted, substituted, linear, and branched dicarboxylic acids, the lower alkyl esters of dicarboxylic acids having from 2 carbons to 36 carbons, and bisglycolate esters of dicarboxylic acids. Specific examples of the desirable dicarboxylic acid component include terephthalic acid, dimethyl terephthalate, isophthalic acid, dimethyl isophthalate, 2,6-naphthalene dicarboxylic acid, dimethyl-2,6-naphthalate, 2,7-naphthalene dicarboxylic acid, dimethyl-2,7-naphthalate, metal salts of 5-sulfoisophthalic acid, sodium dimethyl-5-sulfoisophthalate, lithium dimethyl-5-sulfoisophthalate, 3,4′-diphenyl ether dicarboxylic acid, dimethyl-3,4′diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylic acid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid), dimethyl-4,4′-methylenebis(benzoate), bis(2-hydroxyethyl)terephthalate, bis(2-hydroxyethyl)isophthalate, bis(3-hydroxypropyl)terephthalate, bis(3-hydroxypropyl)isophthalate, bis(4-hydroxybutyl)terephthalate, bis(4-hydroxybutyl)isophthalate, oxalic acid, dimethyl oxalate, malonic acid, dimethyl malonate, succinic acid, dimethyl succinate, methylsuccinc acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, bis(2-hydroxyethyl)glutarate, bis(3-hydroxypropyl)glutarate, bis(4-hydroxybutyl)glutarate, and the like and mixtures derived therefrom.

Preferably, the dicarboxylic acid component is an aromatic dicarboxylic acid component. Preferably the aromatic dicarboxylic acid component is derived from terephthalic acid, dimethyl terephthalate, bis(2-hydroxyethyl)terephthalate, bis(3-hydroxypropyl)terephthalate, bis(4-hydroxybutyl)terephthalate, isophthalic acid, dimethyl isophthalate, bis(2-hydroxyethyl)isophthalate, bis(3-hydroxypropyl)isophthalate, bis(4-hydroxybutyl)isophthalate, 2,6-naphthalene dicarboxylic acid, dimethyl-2,6-naphthalate, and mixtures derived therefrom. More preferably, the aromatic dicarboxylic acid is terephthalic acid and isophthalic acid and lower alkyl esters, such as dimethyl terephthalate and dimethyl isophthalate, and glycolate esters, such as bis(2-hydroxyethyl)terephthalate, bis(2-hydroxyethyl)isophthalate, bis(3-hydroxypropyl)terephthalate, bis(3-hydroxypropyl)isophthalate, bis(4-hydroxybutyl)terephthalate, bis(4-hydroxybutyl)isophthalate, and the like and mixtures thereof. Typically the dicarboxylic acid is incorporated into the polyester composition at a level between about 90 and about 110 mole % based on the total moles of the glycol component. Preferably, the dicarboxylic acid is incorporated into the polyester composition at a level between about 95 and about 105, about 97.5 to about 102.5, or about 100, mole % based on the total moles of the glycol component.

The second composition can comprise at least one glycol including unsubstituted, substituted, straight chain, branched, cyclic aliphatic, aliphatic-aromatic or aromatic diols having from 2 carbon atoms to 36 carbon atoms. Specific examples of the desirable other glycol component include ethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, dimer diol, 4,8-bis(hydroxymethyl)-tricyclo[5.2.1.0/2.6]decane, 1,4-cyclohexanedimethanol, isosorbide, di(ethylene glycol), tri(ethylene glycol), and the like and mixtures derived therefrom. This should not be taken as limiting. Essentially any glycol known within the art may find use within the present invention. Preferably, the glycol component is ethylene glycol, 1,3-propanediol, 1,4-butanediol, 1,4-cyclohexanedimethanol, and mixtures thereof.

The oiligomer can comprise from about 2 to about 100 repeat unites derived from the acid and glycol. Because an oligomer and process for producing it are well known to one skilled in the art, the description of which is omitted herein.

The optional polyfunctional branching agent component includes any material with three or more carboxylic acid functions, hydroxy functions or a mixture thereof. Specific examples of the desirable polyfunctional branching agent component include 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid, 1,2,4,5-benzenetetracarboxylic acid, (pyromellitic acid), 1,2,4,5-benzenetetracarboxylic dianhydride, (pyromellitic anhydride), 3,3′,4,4′-benzophenonetetracarboxylic dianhydride, 1,4,5,8-naphthalenetetracarboxylic dianhydride, citric acid, tetrahydrofuran-2,3,4,5-tetracarboxylic acid, 1,3,5-cyclohexanetricarboxylic acid, pentaerythritol, glycerol, 2-(hydroxymethyl)-1,3-propanediol, 2,2-bis(hydroxymethyl)propionic acid, and the like and mixture therefrom. Essentially any polyfunctional material which includes three or more carboxylic acid or hydroxyl functions may find use in the invention. Said polyfunctional branching agent may be included when higher resin melt viscosity is desired for specific enduses. Examples of said enduses may include melt extrusion coatings, melt blown films or containers, foam and the like. Preferably, the polyester composition of the present invention will include 0 to 1.0 mole % of said polyfunctional branching agent based on 100 mole % of the dicarboxylic acid component.

The carbon black component can have a DBP greater than about 420 cc/100 g. Typically, such carbon black materials have nitrogen adsorption surface areas greater than about 1,000 m²/g. A commercial example of such a carbon black component suitable within the present invention is Ketjenblack® EC 600 JD carbon black available from the Akzo Company. The Ketjenblack® EC 600 JD carbon black is reported to have a dibutyl phthalate absorption of between 480 and 520 cc/100 g and a nitrogen adsorption between 1250 and 1270 m²/g. The level of the carbon black material to be incorporated into the polyester compositions of the present invention allow for the entire range of electrical properties desired; antistatic, static dissipating or moderately conductive, and conductive. The carbon black component incorporated into the polyester compositions of the present invention can be equal to or less than about 4.5 weight %. Preferably, the carbon black component incorporated into the polyester compositions of the present invention is between about 0.5 to about 4, or about 1 to about 3.5, weight % based on enhanced electrical properties and reduced resin melt viscosity.

Carbon black may be used as a dry, raw black, as a slurry in a suitable fluid, preferably the above mentioned glycol component, or as a dispersion in a suitable fluid, preferably the above mentioned glycol component.

To produce a carbon black dispersion, the preferred glycol-carbon black slurry may be subject to intensive mixing and grinding. Suitable types of mechanical dispersing equipment include ball mills, Epenbauch mixers, Kady high shear mill, sandmill, (for example, a 3P Redhead sandmill), and attrition grinding apparatus.

A carbon black dispersion can be produced, for example, through a ball milling process by adding the carbon black to a glycol, such as ethylene glycol, with ceramic or stainless steel balls, followed by rotating the ball mill for the amount of time necessary to produce the desired dispersion. This time can be from 0.5 to 50 hours. The dispersion may further be centrifuged to remove any large particles of the carbon black or the grinding media, if desired.

The amount of carbon black dispersed within the glycol depends on the exact structure and nature of the carbon black to be dispersed.

A dispersing agent, to enhance the wetting of the carbon particles by the glycol and to help maintain the formation of stable dispersions, may be incorporated into the carbon black component, if desired. Examples of suitable dispersing agents include: polyvinylpyrrolidone, epoxidized polybutadiene, a sodium salt of a sulfonated naphthalene, and fatty acids. The level of the dispersing agent can be in the range of about 0.1 to 8 weight % of the total dispersion, (carbon black, dispersing agent, and glycol).

The process of the present invention includes adding the carbon black component within the initial stages of the polyester polymerization process. The carbon black component may be added at any stage of the polyester polymerization prior to the polyester achieving an inherent viscosity of above about 0.20 dL/g. The carbon black component may be added at the monomer stage, such as with the dicarboxylic acid or with the glycol, or to the initial (trans)esterification product, (precondenstates), ranging from the bis(glycolate) to polyester oligomers with degrees of polymerization, (DP), of about 10 or less. More preferably, the carbon black is added with the glycol or to the initial (trans)esterification product.

The polyester compositions of the present invention may be prepared by conventional polycondensation techniques. The product compositions may vary somewhat based on the method of preparation used, particularly in the amount of glycol that is present within the polymer.

These methods include the reaction of the glycol monomers with the acid chlorides. For example, acid chlorides of the dicarboxylic acid component may be combined with the glycol component in a solvent, such as toluene, in the presence of a base, such as pyridine, which neutralizes the hydrochloric acid as it is produced. Such procedures are known. See, e.g., R. Storbeck, et al., in J. Appl. Polymer Science, Vol. 59, pp. 1199-1202 (1996). Other well known variations using acids chlorides may also be used, such as the interfacial polymerization method, or the monomers may simply be stirred together while heating.

When the polymer is made using acid chlorides, the ratio of the monomer units in the product polymer is about the same as the ratio of reacting monomers. Therefore, the ratio of monomers charged to the reactor is about the same as the desired ratio in the product. A stoichiometric equivalent of the glycol components and the dicarboxylic acid components generally can be used to obtain a high molecular weight polymer.

The polyester compositions may be produced through a melt polymerization method. In the melt polymerization method, the dicarboxylic acid component, (either as acids, esters, bisglycolates or mixtures thereof), the glycol component, the carbon black component, and optionally the polyfunctional branching agent, are combined in the presence of a catalyst and heated to a high enough temperature that the monomers combine to form esters and diesters, then oligomers, and finally polymers. The polymeric product at the end of the polymerization process is a molten product. Generally, the glycol component is volatile and distills from the reactor as the polymerization proceeds. Such procedures are generally known in the art.

The melt process conditions such as the amounts of monomers used can depend on the polymer composition that is desired. The amount of glycol, dicarboxylic acid, carbon black, and optional branching agent are desirably chosen so that the final polymeric product contains the desired amounts of the various monomer units, desirably with equimolar amounts of monomer units derived from the respective glycol and dicarboxylic acid components. Because of the volatility of some of the monomers (especially some of the glycol components) and depending on such variables as whether the reactor is sealed (i.e., is under pressure), the polymerization temperature ramp rate, and the efficiency of the distillation columns used in synthesizing the polymer, some of the monomers may need to be included in excess at the beginning of the polymerization reaction and removed by distillation as the reaction proceeds. This is particularly true of the glycol component.

Excesses of the dicarboxylic acid and the glycol can be charged, and the excess dicarboxylic acid and glycol can be removed by distillation or other means of evaporation as the polymerization reaction proceeds. For example, ethylene glycol, 1,3-propanediol, and 1,4-butanediol are desirably charged at a level 10 to 100, 40 to 100, or 20 to 70, % greater than the desired incorporation level in the final polymer.

In the polymerization process, the compositions comprising the monomers can be combined, and heated gradually with mixing with a catalyst or catalyst mixture to a temperature in the range of 200° C. to about 330° C., desirably 220° C. to 295° C. The exact conditions and the catalysts depend on whether the dicarboxylic acid component is polymerized as true acids, as dimethyl esters, or as bisglycolates. The catalyst may be included initially with the reactants, and/or may be added one or more times to the mixture as it is heated. The catalyst used may be modified as the reaction proceeds. The heating and stirring are continued for a sufficient time and to a sufficient temperature, generally with removal by distillation of excess reactants, to yield a molten polymer having a high enough molecular weight to be suitable for making fabricated products.

Catalysts that may be used include salts of Li, Ca, Mg, Mn, Zn, Pb, Sb, Sn, Ge, and Ti, such as acetate salts and oxides, including glycol adducts, and Ti alkoxides. These are generally known in the art, and the description of specific catalyst or combination or sequence of catalysts used is omitted for the interest of brevity. Essentially any catalyst system known in the art can be used.

Polymers can be made by the melt condensation process disclosed above. To give the desired physical properties, the polyester compositions preferably have an inherent viscosity, which is an indicator of molecular weight, of at least equal to or greater than 0.25. More preferably, the inherent viscosity, (IV), of said polyester compositions can be at least equal to 0.35 dL/g, as measured on a 0.5 percent (weight/volume) solution of the polyester in a 50:50 (weight) solution of trifluoroacetic acid:dichloromethane solvent system at room temperature. Most preferably, the IV can be at least equal to or greater than 0.50 dL/g. Higher inherent viscosities are desirable for many other applications, such as films, bottles, sheet, molding resin and the like. The polymerization conditions may be adjusted to obtain the desired IV up to at least about 0.5 and desirably higher than 0.65 dL/g. Further processing of the polyester may achieve IV of 0.7, 0.8, 0.9, 1.0, 1.5, 2.0 dL/g or higher.

The molecular weight is normally not measured directly. Instead, the IV of the polymer in solution or the melt viscosity is used as an indicator of molecular weight. The IVs are an indicator of molecular weight for comparisons of samples within a polymer family, such as poly(ethylene terephthalate), poly(butylene terephthalate), etc., and are used as the indicator of molecular weight herein.

Solid state polymerization may be used to achieve even higher IVs (molecular weights). The product made by melt polymerization, after extruding, cooling and pelletizing, may be essentially noncrystalline. Noncrystalline materials can be made semicrystalline by heating it to a temperature above the glass transition temperature for an extended period of time. This induces crystallization so that the product can then be heated to a higher temperature to raise the molecular weight.

The polymer may be crystallized prior to solid state polymerization by treatment with a relatively poor solvent for polyesters which induces crystallization. Such solvents reduce the glass transition temperature (Tg) allowing for crystallization. Solvent induced crystallization is known for polyesters and is described in U.S. Pat. No. 5,164,478 and U.S. Pat. No. 3,684,766.

Semicrystalline polymer can be subject to solid state polymerization by placing the pelletized or pulverized polymer into a stream of an inert gas, usually nitrogen, or under a vacuum of 1 Torr, at an elevated temperature, but below the melting temperature of the polymer for an extended period of time.

The polyester may be used with additives known within the art. Such additives may include thermal stabilizers, for example, phenolic antioxidants, secondary thermal stabilizers, for example, thioethers and phosphites, UV absorbers, for example benzophenone- and benzotriazole-derivatives, UV stabilizers, for example, hindered amine light stabilizers (HALS), and the like. Said additives may further include plasticizers, processing aides, flow enhancing additives, lubricants, pigments, flame retardants, impact modifiers, nucleating agents to increase crystallinity, antiblocking agents such as silica, base buffers, such as sodium acetate, potassium acetate, and tetramethyl ammonium hydroxide, (for example; as disclosed in U.S. Pat. No. 3,779,993; U.S. Pat. No. 4,340,519; U.S. Pat. No. 5,171,308; U.S. Pat. No. 5,171,309 and U.S. Pat. No. 5,219,646 and references cited therein), and the like.

Molding polyester into shaped articles may be performed by any process known within the art, such as compression molding or melt forming. Melt forming can be carried out by the usual methods for thermoplastics, such as injection molding, thermoforming, extrusion, blow molding, or any combination of these methods.

Compression molding may be performed through any process known within the art. Examples of compression molding processes include, for example; hand molds, semiautomatic molds, and automatic molds. The three common types of mold designs include open flash, fully positive, and semipositive. Within general compression molding operations, the polyester of the present invention, in essentially any form, such as powder, pellet, or disc, is preferably dried and heated. The heated polyester is then loaded into a mold, which is typically held at a temperature between 150° C. to 300° C., depending on the exact polyester to be used. The mold is then partially closed and pressure is exerted. The pressure is generally between 2,000 to 5,000 psi, but depends on the exact compression molding process utilized, the exact polyester material, the part to be molded and the like. The polyester is melted by the action of the heat and the exerted pressure and flows into the recesses of the mold to form the shaped molded article.

Injection molding is the most preferred process to mold the shaped articles of the present invention. Injection molding may be performed through any process known within the art. The polyester of the present invention may be in essentially any form, such as powder, pellet or disc. Pellet form is preferable for ease of conveyance. The polyester of the present invention is preferably dried prior to use within molding operations. Generally, the polyester of the present invention is fed into the back end of an extruder, typically with an automatic feeder, such as a K-Tron® or Accurate® feeder. Other desired additives, plasticizers, blend materials, and the like, maybe precompounded with the polyester or cofed to the extruder. The polyester composition is then melted within the extruder and conveyed to the end of the extruder. Typically a hydraulic cylinder then pushes the screw forward to inject the molten resin composition into the mold. The mold is generally clamped together with pressure. The mold temperature is generally set at such a temperature as to allow the polyester composition to crystallize and set up. Generally it can be between about room temperature and 200° C. The mold may be heated by steam, hot water, gas, electricity (such as resistance heaters, band heaters, low-voltage heaters, and induction heaters), and hot oil. Typically, the mold temperature is set to provide the shortest mold cycle time possible. For slow crystallizing materials, such as poly(ethylene terephthalate), typically electrical heaters or hot oil is desired. For rapidly crystallizing materials, such as poly(1,4-butylene terephthalate), steam heat may be sufficient. Once the shaped article has solidified, the mold pressure is released, the mold opened and the part is ejected from the mold cavity, typically through the help of knockout pins, ejector pins, knockout plates, stripper rings, compressed air, or combinations thereof.

Molding may provide a wide variety of shaped articles, including, for example; discs, plaques, bushings, automotive parts, such as door handles, window cranks, electrical parts, electronic mechanical parts, electrochemical sensors, positive temperature coefficient devices, temperature sensors, semiconductive shields for conductor shields, electrothermal sensors, electrical shields, high permittivity devices, housing for electronic equipment, containers and pipelines for flammable solids, powders, liquids, and gases, and the like. For the polyester compositions produced by the processes of the present invention which incorporate low levels of carbon black, molded parts produced therefrom will find utility for laser marking for identification purposes. The compositions described herein are particularly useful as “appearance parts”, that is parts in which the surface appearance is important. This is applicable whether the composition's surface is viewed directly, or whether it is coated with paint or another material such as a metal. Such parts include automotive body panels such as fenders, fascia, hoods, tank flaps, rocker panels, spoilers, and other interior and exterior parts; interior automotive panels, automotive trim parts, appliance parts such as handles, control panels, chassises (cases), washing machine tubs and exterior parts, interior or exterior refrigerator panels, and dishwasher front or interior panels; power tool housings such as drills and saws; electronic cabinets and housings such as personal computer housings, printer housings, peripheral housings, server housings; exterior and interior panels for vehicles such as trains, tractors, lawn mower decks, trucks, snowmobiles, aircraft, and ships; decorative interior panels for buildings; furniture such as office and/or home chairs and tables; and telephones and other telephone equipment. These parts may be painted or they may be left unpainted in the color of the composition. Automotive body panels are an especially challenging application. These materials can have smooth and reproducible appearance surfaces, be heat resistant so they can pass through without significant distortion automotive E-coat and paint ovens where temperatures may reach as high as about 200° C. for up to 30 minutes for each step, be tough enough to resist denting or other mechanical damage from minor impacts.

The incorporation of the carbon black allows for the parts to dissipate electrical charges formed on the part as it is being electrostatically painted, providing an even coating of paint over the entire part. Electrostatic painting of substrates is desirable because it can reduce paint waste and emissions as compared to non-electrostatic painting processes. This allows for relatively large parts to be consistently painted without color differences over the surface of the part. The polyester can be electrostatically paintable while maintaining the majority of their desirable physical properties due to the low carbon loadings incorporated therein.

Polymeric films have a variety of uses, such as in packaging, especially of foodstuffs, adhesives tapes, insulators, capacitors, photographic development, X-ray development and as laminates, for example. Of particular note, the films produced from the polyester compositions produced by the processes of the present invention may find utility in EMI shielding, as protective film for microwave antennas, as a radome, as a sunshield, packaging for electrically sensitive products, such as electronics, conductive film, charge-transporting components for electrographic imaging equipment, and the like. Films produced may find utility for laser marking for identification purposes. For many of these uses, the heat resistance of the film is an important factor. Therefore, a higher melting point, glass transition temperature, and crystallinity level are desirable to provide better heat resistance and more stable electrical characteristics. Further, it is desired that these films have good barrier properties, for example; moisture barrier, oxygen barrier and carbon dioxide barrier, good grease resistance, good tensile strength and a high elongation at break.

The polyesters may be formed into a film for use in any one of the many different applications, such as packaging, labels, EMI shielding, or the like. While not limiting, the monomer composition of the polyester polymer is preferably chosen to result in a partially crystalline polymer desirable for the formation of film, wherein the crystallinity provides strength and elasticity. As first produced, the polyester is generally semi-crystalline in structure. The crystallinity increases on reheating and/or stretching of the polymer, as occurs in the production of film.

Film can be made from the polymer by any process known in the art. For example, thin films may be formed through dipcoating as taught within U.S. Pat. No. 4,372,311, through compression molding as taught within U.S. Pat. No. 4,427,614, through melt extrusion as taught within U.S. Pat. No. 4,880,592, through melt blowing as taught within U.S. Pat. No. 5,525,281, or other art processes. The difference between a film and a sheet is the thickness, but there is no set industry standard as to when a film becomes a sheet. For purposes of this invention, a film is less than or equal to 0.25 mm (10 mils) thick, preferably between about 0.025 mm and 0.15 mm (1 mil and 6 mils). However, thicker films can be formed up to a thickness of about 0.50 mm (20 mils).

The film of the present invention is preferably formed by either solution casting or extrusion, which is well known to one skilled in the art and the description of which is omitted for the interest of brevity.

The incorporation of the carbon black allows for the sheets to dissipate electrical charges formed on the part as it is being electrostatically painted, providing an even coating of paint over the entire sheet. This allows for relatively large sheets to be consistently painted without color differences over the surface of the part. The polyester compositions can be electrostatically paintable while maintaining the majority of their desirable physical properties due to the low carbon loadings incorporated therein. For the polyester compositions sheets produced therefrom may find utility for laser marking for identification purposes.

Sheets may be formed by extrusion, solution casting or injection molding. The parameters for each of these processes can be easily determined by one of ordinary skill in the art depending upon viscosity characteristics of the copolyester and the desired thickness of the sheet. Because such methods are well known, the description is omitted herein.

The sheets may be thermoformed by any known method into any desirable shape, such as covers, skylights, shaped greenhouse glazings, displays, food trays, and the like. The thermoforming is accomplished by heating the sheet to a sufficient temperature and for sufficient time to soften the copolyester so that the sheet can be easily molded into the desired shape. In this regard, one of ordinary skill in the art can easily determine the optimal thermoforming parameters depending upon the viscosity and crystallization characteristics of the polyester sheet and the description thereof is omitted herein for the interest of brevity.

The polyesters of the present invention may also find utility as plastic containers. Plastic containers are widely used for foods and beverages, and also for non-food materials. Poly(ethylene terephthalate) (PET) is used to make many of these containers because of its appearance (optical clarity), ease of blow molding, chemical and thermal stability, and its price. PET is generally fabricated into bottles by blow molding processes, and generally by stretch blow molding. For the polyester compositions produced by the processes of the present invention that incorporate low levels of carbon black, containers produced therefrom may find utility for laser marking for identification purposes. In addition, very low levels of incorporated carbon black, in the 5 to 25 ppm range, may function as reheat catalysts in the stretch blow molding processes as the preform is heated to form the final container, such as a soda bottle.

The containers may be made by any method known in the art, such as extrusion, injection molding, injection blow molding, rotational molding, thermoforming of a sheet, and stretch-blow molding. Because the methods are well known to one skilled in the art, the description of which is omitted herein.

The polyesters may further find utility in the form of fibers. Polyester fibers are produced in large quantities for use in a variety of applications. In particular, these fibers are desirable for use in textiles, particularly in combination with natural fibers such as cotton and wool. Clothing, rugs, and other items may be fashioned from these fibers. Further, polyester fibers are desirable for use in industrial applications due to their elasticity and strength. In particular, they are used to make articles such as tire cords and ropes.

Fibers formed thereof can be antistatic and antisoiling. The fiber may take many forms, including homogeneous and bicomponent. For example, the polyester compositions of the present invention may serve as a conductive core covered by a dielectric sheath material. A significant advantage that the polyester compositions of the present invention possess over the materials of the art is that they maintain the majority of their physical properties due to the relatively low level of carbon black required to provide the desired electrical properties. Antistatic fibers produced from the polyester compositions of the present invention are capable of providing antistatic protection in all types of textile end uses, including, for example, knitted, tufted, woven, and nonwoven textiles. Antistatic monofilaments would find utility as hairbrushes, especially in low humidity environments and, after being woven into a fabric, as belting materials for, for example, paper production clothing, poultry belts, package conveyance belts, and the like.

As is well known, static electricity is generated and transferred as one walks across a conventional carpet made from hydrophobic fiber materials, such as nylon fibers, acrylic fibers, polypropylene fibers, and polyester fibers. When a person walking across the carpet becomes grounded, such as through touching a doorknob or a metal cabinet, an electrical shock exceeding 3500 volts occurs providing discomfort to the person. The addition of the fiber produced form the polyester compositions of the present invention may provide antistatic protection to such carpet structures. The accumulation of static electricity in textiles is not only an annoyance, such as the above example or such as items of apparel clinging to the body and being attracted to other garments, especially in hospital gowns and garments, fine particles of lint and dust being attracted to and gathering on upholstery fabrics, and increasing the frequency of required cleaning, but can also constitute a real danger, such as the discharge of static electricity resulting in sparks capable of igniting flammable mixtures commonly found in hospitals and the like. The is reduction of these dangers with antistatic textiles can be an improvement.

The term “fibers” as used herein is meant to include continuous monofilaments, non-twisted or entangled multifilament yarns, staple yarns, spun yarns, melt blown fibers, non-woven materials, and melt blown non-woven materials. Such fibers may be used to form uneven fabrics, knitted fabrics, fabric webs, or any other fiber-containing structures, such as tire cords.

Synthetic fibers, such as nylon, acrylic, polyesters, and others, are made by spinning and drawing the polymer into a filament, which is then formed into a yarn by winding many filaments together. These fibers are often treated mechanically and/or chemically to impart desirable characteristics such as strength, elasticity, heat resistance, hand (feel of fabric), and the like as known in the art based on the desired end product to be fashioned from fibers.

The polyester can be a partially crystalline polymer. The crystallinity can be desirable for the formation of fibers, providing strength and elasticity. As first produced, the polyester is mostly amorphous in structure. In preferred embodiments, the polyester polymer readily crystallizes on reheating and/or extension of the polymer.

In the process of the invention, fibers are made from the polymer by any process known in the art. Generally, however, melt spinning is preferred for polyester fibers. Because the methods are well known to one skilled in the art, the description of which is omitted herein.

Further, the polyester polymer may be used with another synthetic or natural polymer to form heterogenous fiber, thereby providing a fiber with improved properties. The heterogeneous fiber may be formed in any suitable manner, such as side-by-side, sheath-core, and matrix designs, as is known within the art.

For some enduses, such as monofilaments, the polyesters of the present invention may be stabilized with an effective amount of hydrolysis stabilization additive. Said hydrolysis stabilization additive chemically reacts with the carboxylic acid endgroups and is preferably carbodiiimides.

The hydrolysis stabilization additive may be any known material in the art which enhances the stability of the polyester monofilament to hydrolytic degradation. Examples of said hydrolysis stabilization additive may include: diazomethane, carbodiimides, epoxides, cyclic carbonates, oxazolines, aziridines, keteneimines, isocyanates, alkoxy end-capped polyalkylene glycols, and the like.

The amount of hydrolysis stabilization additive required to lower the carboxyl concentration of the polyester during its conversion to monofilaments is dependent on the carboxyl content of the polyester prior to extrusion into monofilaments. In general, the amount of hydrolysis stabilization additive used will range from 0.1 to 10.0 weight percent based on the polyester. Preferably the amount of the hydrolysis stabilization additive used is in the range of 0.2 to 4.0 weight percent.

The hydrolysis stabilization additive may be incorporated within the polyesters through a separate melt compounding process utilizing any known intensive mixing process, such as extrusion through a single screw or twin screw extruder, through intimate mixing with the solid granular material, such as mixing, stirring or pellet blending operations, or through cofeeding within the monofilament process. Preferably, the hydrolysis additive is incorporated through cofeeding within the monofilament process.

The polyester may also find utility when formed into shaped foamed articles. Thermoplastic polymeric materials are foamed to provide low density articles, such as films, cups, food trays, decorative ribbons, furniture parts and the like. For example, polystyrene beads containing low boiling hydrocarbons, such as pentane, are formed into light weight foamed cups for hot drinks such as coffee, tea, hot chocolate and the like. Polypropylene can be extruded in the presence of blowing agents such as nitrogen or carbon dioxide gas to provide decorative films and ribbons for package wrappings. Also, polypropylene can be injection molded in the presence of blowing agents to form lightweight furniture parts such as table legs and to form lightweight chairs. Because the methods are well known to one skilled in the art, the description of which is omitted herein.

A further aspect of the present invention includes processes to produce polyester compositions with the desired properties, such as electrical properties, which incorporate from equal to or less than about 9 weight percent of carbon blacks having a DBP between about 220 cc/100 g and about 420 cc/100 g, the products produced thereby, and shaped articles formed from said products. The polyester can incorporate from about 2.0 to about 7.5 weight % of carbon blacks having a DBP between about 220 cc/100 g and about 420 cc/100 g. More preferably, said polyester compositions incorporate from about 2.5 to about 6 weight % of carbon blacks having a DBP between about 220 cc/100 g and about 420 cc/100 g. Preferably, the carbon black filler has been deagglomerated prior to use. At the low ppm levels, (5 to 25 ppm), the carbon blacks serve as reheat catalysts for preforms within the melt blown molding processes to produce containers, such as soda bottles. At the intermediate levels, for example between 0.05 and 0.5 weight % based on the total composition weight, the carbon blacks have been found to serve as potent nucleation agents to enhance the rate of crystallization of certain polyester compositions.

The carbon black component can have a dibutyl DBP between about 220 cc/100 g and about 420 cc/100 g. While not limiting, such carbon black materials further can have nitrogen adsorption surface areas greater than about 700 m²/g. Commercial examples of such carbon black components suitable within the present invention is Ketjenblack® EC 300 J carbon black available from the Akzo Company, Black Pearls® 2000 carbon black available from the Cabot Corporation, and Printex® XE-2 carbon black available from the Cabot Corporation. The Ketjenblack® EC 300 J carbon black is reported to have a dibutyl phthalate absorption of between 350 and 385 cc/100 grams and a nitrogen adsorption of 800 m²/g. The Black Pearls® 2000 carbon black is reported to have a dibutyl phthalate absorption of 330 cc/100 grams and a nitrogen adsorption of between 1,475 and 1,635 m²/g. The Printex® XE-2 carbon black is reported to have a dibutyl phthalate absorption of between 380 and 400 cc/100 grams and a nitrogen adsorption of 1,300 m²/g. The level of the carbon black material to be incorporated into the polyester compositions of the present invention allow for the entire range of electrical properties desired; antistatic, static dissipating or moderately conductive, and conductive. Preferably, the carbon black component incorporated into the polyester is between about 2.0 to about 7.5 weight % based on improved electrical properties and reduced resin melt viscosity. More preferably, the carbon black component incorporated into the polyester compositions of the present invention is between about 2.5 to about 6 weight % based on improved electrical properties and reduced resin melt viscosity.

The carbon black component may be added to the process for the present invention as a dry, raw black, as a slurry in a suitable fluid, preferably the above mentioned glycol component, or as a dispersion in a suitable fluid, preferably the above mentioned glycol component. Preferably, the carbon black is added to the polyester polymerization process as a deagglomerated dispersion in, preferably, the glycol utilized within the certain polyester composition to be produced, as described above. It has been surprisingly found within the present invention, that deagglomeration of the carbon black provides significant enhancement in the conductivity resulting in the final polyester composition produced through the process of the present invention.

The polyester compositions produced by the process of the present invention may incorporate additives, plasticizers, fillers, other blend materials, and the like, as described above. The polyester compositions produced by the process of the present invention may be formed into shaped articles, such as molded parts, films, sheets, fiber, monofilament, nonwoven structures, melt blown containers, coatings, laminates, and the like, as described above.

A further aspect of the present invention includes processes to produce polyester compositions with the desired electrical properties which incorporate from about 4 to about 15 weight percent of carbon blacks having a DBP between about 150 cc/100 g and about 210 cc/100 g, the products produced thereby, and shaped articles formed from said products. Preferably, said polyester compositions incorporate from about 5 to about 12.5 weight % of carbon blacks having a DBP between about 150 cc/100 g and about 210 cc/100 g. More preferably, said polyester compositions incorporate from about 6 to about 10 weight % of carbon blacks having a DBP between about 150 cc/100 g and about 210 cc/100 g.

The suitable polyester compositions and processes are as described above. The carbon black can have a DBP between about 150 cc/100 g and about 210 cc/100 g. While not limiting, such carbon black materials further typically have nitrogen adsorption surface areas greater than about 200 m²/g. Commercial examples of such carbon black components suitable within the present invention is Conductex® 975 carbon black available from the Columbian Company, and Vulcan® XC-72 carbon black available from the Cabot Corporation. The Conductex® 975 carbon black is reported to have a dibutyl phthalate absorption of 170 cc/100 grams and a nitrogen adsorption of 250 m²/g. The Vulcan® XC-72 carbon black is reported to have a dibutyl phthalate absorption of between 178 and 192 cc/100 g and a nitrogen adsorption of 245 m²/g. The level of the carbon black material to be incorporated into the polyester allows for the entire range of electrical properties desired; antistatic, static dissipating or moderately conductive, and conductive. Carbon black incorporated into the polyester can be between about 4 to about 15, about 5 to about 12, or about 6 to about 10, weight % based on improved electrical properties and reduced resin melt viscosity.

The process can be the same as that disclosed above.

A further aspect of the present invention includes processes to produce polyester compositions with the desired electrical properties which incorporate mixtures of carbon black particles consisting of at least two carbon blacks selected from the group consisting of (a) carbon blacks having a DBP greater than about 420 cc/100 g, (b) carbon blacks having a DBP between about 220 cc/100 g and about 420 cc/100 g, and (c) carbon blacks having a DBP between about 150 cc/100 g and about 210 cc/100 g, the products produced thereby, and shaped articles formed from said products. Preferably, the level of (a) is about 0.1 to about 4.5, about 0.5 to about 4, or about 0.5 to about 3.5, weight percent based on the weight of the polyester composition. The level of (b) can be about 0.5 to about 9, about 1 to about 7.5, or about 1 to about 6, weight % based on the weight of the polyester composition based on reduced resin melt viscosity. Preferably, the level of (c) is about 1 to about 12.5, about 2 to about 10, or about 2 to about 7.5, weight % based on the weight of the polyester composition based on reduced resin melt viscosity. Preferably, the total level of carbon black (a), (b), and/or (c) is about 1 to about 15, about 1.5 to about 12.5, or about 2 to about 10, weight % based on the weight of the polyester composition based on improved electrical properties and reduced resin melt viscosity. Preferably, the carbon black has been deagglomerated prior to use.

A further aspect of the present invention includes processes to produce polyester compositions with the desired electrical properties which incorporate from about 0.1 to about 15 weight % of carbon blacks having a DBP greater than about 200 cc/100 g and an effective amount of a melt viscosity reducing additive with low volatility, the products produced thereby, and shaped articles formed from said products. Preferably, the melt viscosity reducing additive level is greater than 0.1, or greater than 0.5 weight % based on the polyester composition. The melt viscosity reducing additive can have a boiling point greater than about 200° C., about 250° C., or about 300° C. Preferably, the carbon blacks have a DBP greater than about 300 cc/100 g and the polyester incorporates from about 0.5 to about 10 or 0.5 to about 8 weight % carbon blacks.

### EXAMPLES AND COMPARATIVE EXAMPLES

Test Methods.

Differential Scanning Calorimetry, (DSC), is performed on a TA Instruments Model Number 2920 machine. Samples are heated under a nitrogen atmosphere at a rate of 20 degrees C./minute to 300 degrees C., programmed cooled back to room temperature at a rate of 20 degrees C./minute and then reheated to 300 degrees C. at a rate of 20 degrees C./minute. The observed sample glass transition temperature, (Tg), and crystalline melting temperature, (Tm), noted below were from the second heat.

Inherent Viscosity, (IV), is defined in “Preparative Methods of Polymer Chemistry”, W. R. Sorenson and T. W. Campbell, 1961, p. 35. It is determined at a concentration of 0.5 g/100 mL of a 50:50 weight percent trifluoroacetic acid:dichloromethane acid solvent system at room temperature by a Goodyear R-103B method.

Laboratory Relative Viscosity, (LRV), is the ratio of the viscosity of a solution of 0.6 gram of the polyester sample dissolved in 10 mL of hexafluoroisopropanol, (HFIP), containing 80 ppm sulfuric acid to the viscosity of the sulfuric acid-containing hexafluoroisopropanol itself, both measured at 25 degrees C. in a capillary viscometer. The LRV may be numerically related to IV. Where this relationship is utilized, the term “calculated IV” is noted.

Surface resistivity was measured as per ASTM Method Number D-257. A power supply and an electrometer from the Keithley Company were used within these tests. The polymer pieces were painted with silver paint to provide good electrical contact with the electrodes.

### Example 1

To a 500 milliliter glass flask was added bis(2-hydroxyethyl)terephthalate, (327.73 grams), Ketjenblack® EC 600 JD, (2.50 grams), manganese(II) acetate tetrahydrate, (0.1121 grams), and antimony(III) trioxide, (0.0904 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.5 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.7 hours. 48.57 grams of a colorless distillate was collected over this heating cycle. The reaction mixture was then staged to full vacuum with stirring at 295° C. The resulting reaction mixture was stirred for 1.1 hours under full vacuum, (pressure less than 100 mtorr). The vacuum was then released with nitrogen and the reaction mass allowed to cool to room temperature. An additional 26.87 grams of distillate was recovered and 235.0 grams of a solid product was recovered.

The sample was measured for LRV as described above and was found to have an LRV of 18.89. This sample was calculated to have an inherent viscosity of 0.59 dL/g.

The sample underwent differential DSC analysis. A recrystallization temperature was found on the programmed cool after the first heat cycle with an onset at 210.6° C. and a peak at 205.7° C., (36.40 J/g). A Tg was found with an onset temperature of 77.1° C., a midpoint temperature of 81.1° C., and an endpoint temperature of 85.5° C. A crystalline Tm was observed at 248.9° C., (37.8 J/g).

Surface resistivity was measured on pieces of the polymer produced above and were found to have a surface resistivity at the radius of 7,080 Ohms per square and a surface resistivity at the fracture of 5,340 Ohms per square.

### Example 2

To a 500 milliliter glass flask was added bis(2-hydroxyethyl)terephthalate, (326.08 grams), Ketjenblack® EC 600 JD, (3.75 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.7 hours while under a slow nitrogen purge. After achieving 225° C., the resulting reaction mixture was stirred at 225° C. for 0.6 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.5 hours. 52.26 grams of a colorless distillate was collected over this heating cycle. The reaction mixture was then staged to full vacuum with stirring at 295° C. The resulting reaction mixture was stirred for 3.5 hours under full vacuum, (pressure less than 100 mtorr). The vacuum was then released with nitrogen and the reaction mass allowed to cool to room temperature. An additional 26.0 grams of distillate was recovered and 237.4 grams of a solid product was recovered.

The sample had an LRV of 13.98; an IV of 0.50 dL/g; and a Tg of an onset temperature of 74.9° C. and a midpoint temperature of 78.9° C., and an endpoint temperature of 82.8 C. A crystalline melting temperature, (Tm), was observed at 250.2° C., (49.4 J/g). A recrystallization temperature was found on the DSC programmed cool after the first heat cycle with an onset at 211.9° C., a mid point of 74.9° C., and an point at 82.8° C. The Tm was at 250.6° C., (49.4 J/g). Surface resistivity was at the radius of 1,008 Ohms per 2quare and a surface resistivity at the fracture of 699 Ohms per square.

### Example 3

To a 500 milliliter glass flask was added bis(2-hydroxyethyl)terephthalate, (324.42 grams), Ketjenblack® EC 600 JD, (5.00 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 1.1 hours with stirring under a slow nitrogen purge. The resulting reaction mixture was stirred at 295° C. under a slight nitrogen purge for 0.5 hours. 52.84 grams of a colorless distillate was collected over this heating cycle. The reaction mixture was then staged to full vacuum with stirring at 295° C. The resulting reaction mixture was stirred for 4.1 hours under full vacuum, (pressure less than 100 mtorr). The vacuum was then released with nitrogen and the reaction mass allowed to cool to room temperature. An additional 22.30 grams of distillate was recovered and 227.9 grams of a solid product was recovered.

The sample had an LRV of 13.55 and an IV of 0.49 dL/g. A recrystallization temperature was found on the programmed cool after the first heat cycle with an onset at 212.1° C. and a peak at 207.0° C., (47.4 J/g). A glass transition temperature was found with an onset temperature of 78.4° C., a midpoint temperature of 81.4° C., and an endpoint temperature of 84.3° C. A crystalline melting temperature, (Tm), was observed at 249.6° C., (44.1 J/g).

Surface resistivity was measured on pieces of the polymer produced above and were found to have a surface resistivity at the radius of 306 Ohms per square, a surface resistivity at the fracture of 237 Ohms per square, and a surface resistivity at the top of 168 Ohms per square (multiple measurements being made per irregular shape of sample supplied).

### Example 4

To a 1 liter glass flask was added bis(2-hydroxyethyl)terephthalate, (324.42 grams), a ball milled dispersion of 2.9 weight percent Ketjenblack® EC 600 JD and 0.7 weight percent of poly(vinyl pyrrolidone) in ethylene glycol, (172.41 grams, provided as Aquablak® 6026 from Solution Dispersions, Inc.), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.6 hours. 215.68 grams of a colorless distillate was collected over this heating cycle. The reaction mixture was then staged to full vacuum with stirring at 295° C. The resulting reaction mixture was stirred for 2.0 hours under full vacuum, (pressure less than 100 mtorr). The vacuum was then released with nitrogen and the reaction mass allowed to cool to room temperature. An additional 29.90 grams of distillate was recovered and 222.5 grams of a solid product was recovered.

The sample was measured for laboratory relative viscosity, (LRV), as described above and was found to have an LRV of 18.53. This sample was calculated to have an inherent viscosity of 0.58 dL/g.

The sample underwent differential scanning calorimetry, (DSC), analysis. A recrystallization temperature was found on the programmed cool after the first heat cycle with an onset at 213.3° C. and a peak at 208.1° C., (48.5 J/g). A glass transition temperature, (Tg), was found with an onset temperature of 75.1° C., a midpoint temperature of 75.2° C., and an endpoint temperature of 75.9° C. A crystalline melting temperature, (Tm), was observed at 248.7° C., (39.8 J/g).

Surface resistivity was measured on pieces of the polymer produced above and were found to have a surface resistivity at the radius of 340 Ohms per square, a surface resistivity at the fracture of 298 Ohms per square, and a surface resistivity at the top of 264 Ohms per square.

### Example 5

To a 250 milliliter glass flask was added dimethyl terephthalate, (92.38 grams), 1,3-propanediol, (47.06 grams), Ketjenblack® EC 600 JD, (2.00 grams), and titanium(IV) isopropoxide, (0.1188 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.2 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 255° C. over 0.5 hours with stirring under a slow nitrogen purge. The resulting reaction mixture was stirred at 255° C. under a slight nitrogen purge for 0.7 hours. 20.34 grams of a colorless distillate was collected over this heating cycle. The reaction mixture was then staged to full vacuum with stirring at 255° C. The resulting reaction mixture was stirred for 1.9 hours under full vacuum, (pressure less than 100 mtorr). The vacuum was then released with nitrogen and the reaction mass allowed to cool to room temperature. An additional 3.20 grams of distillate was recovered and 90.5 grams of a solid product was recovered.

The sample was measured for laboratory relative viscosity, (LRV), as described above and was found to have an LRV of 31.12. This sample was calculated to have an inherent viscosity of 0.81 dL/g.

The sample underwent differential scanning calorimetry, (DSC), analysis. A recrystallization temperature was found on the programmed cool after the first heat cycle with an onset at 183.2° C. and a peak at 173.5° C., (55.2 J/g). A crystalline melting temperature, (Tm), was observed at 232.5° C., (48.5 J/g).

### Example 6

To a 250 milliliter glass flask was added dimethyl terephthalate, (87.54 grams), ethylene glycol, (62.72 grams), 1,4-cyclohexanedimethanol, (20.90 grams), Ketjenblack® EC 600 JD, (2.02 grams), manganese(II) acetate tetrahydrate, (0.0447 grams), and antimony(III) trioxide, (0.0355 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.3 hours while under a slow nitrogen purge. The reaction mixture was then stirred and heated to 200° C. over 0.1 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 1.0 hour while under a slow nitrogen purge. The reaction mixture was heated to 295° C. over 0.7 hours with stirring under a slow nitrogen purge. The resulting reaction mixture was stirred at 295° C. under a slight nitrogen purge for 0.7 hours. 50.46 grams of a colorless distillate was collected over this heating cycle. The reaction mixture was then staged to full vacuum with stirring at 295° C. The resulting reaction mixture was stirred for 0.6 hours under full vacuum, (pressure less than 100 mtorr). The vacuum was then released with nitrogen and the reaction mass allowed to cool to room temperature. An additional 10.25 grams of distillate was recovered and 93.3 grams of a solid product was recovered.

The sample was measured for laboratory relative viscosity, (LRV), as described above and was found to have an LRV of 18.92. This sample was calculated to have an inherent viscosity of 0.59 dL/g.

The sample underwent differential scanning calorimetry, (DSC), analysis. A glass transition temperature, (Tg), was found with an onset temperature of 76.9° C., and an endpoint temperature of 81.5° C. A crystalline melting temperature, (Tm), was not observed.

### Example 7

To a 500 milliliter glass flask was added bis(2-hydroxyethyl)terephthalate, (322.77 grams), Ketjenblack® EC 600 JD, (6.25 grams), manganese(II) acetate tetrahydrate, (0.1108 grams), and antimony(III) trioxide, (0.0897 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.7 hours while under a slow nitrogen purge. The reaction mixture was heated to 295° C. over 0.7 hours with stirring under a slow nitrogen purge. The resulting reaction mixture was stirred at 295° C. under a slight nitrogen purge for 1.2 hours. 40.92 grams of a colorless distillate was collected over this heating cycle. The reaction mixture was then staged to full vacuum with stirring at 295° C. The resulting reaction mixture was stirred for 0.8 hours under full vacuum, (pressure less than 100 mtorr). The vacuum was then released with nitrogen and the reaction mass allowed to cool to room temperature. An additional 33.21 grams of distillate was recovered and 235.0 grams of a solid product was recovered.

The sample was measured for laboratory relative viscosity, (LRV), as described above and was found to have an LRV of 18.80. This sample was calculated to have an inherent viscosity of 0.59 dL/g.

The sample underwent differential scanning calorimetry, (DSC), analysis. A recrystallization temperature was found on the programmed cool after the first heat cycle with an onset at 212.5° C. and a peak at 208.3° C., (43.9 J/g). A glass transition temperature, (Tg), was found with an onset temperature of 73.0° C., a midpoint temperature of 80.3° C., and an endpoint temperature of 87.4° C. A crystalline melting temperature, (Tm), was observed at 250.5° C., (44.1 J/g).

Surface resistivity was measured on pieces of the polymer produced above and were found to have a surface resistivity at the radius of 103 Ohms per square and a surface resistivity at the fracture of 163 Ohms per square.

### Example 8

To a 250 milliliter glass flask was added dimethyl terephthalate, (86.06 grams), 1,4-butanediol, (51.92 grams), Ketjenblack EC 600 JD, (2.50 grams), and titanium(IV) isopropoxide, (0.1188 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.2 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.5 hours while under a slow nitrogen purge. The reaction mixture was heated to 255° C. over 0.5 hours with stirring under a slow nitrogen purge. The resulting reaction mixture was stirred at 255° C. under a slight nitrogen purge for 0.6 hours. 21.92 grams of a colorless distillate was collected over this heating cycle. The reaction mixture was then staged to full vacuum with stirring at 255° C. The resulting reaction mixture was stirred for 1.5 hours under full vacuum, (pressure less than 100 mtorr). The vacuum was then released with nitrogen and the reaction mass allowed to cool to room temperature. An additional 1.10 grams of distillate was recovered and 92.8 grams of a solid product was recovered.

The sample was measured for laboratory relative viscosity, (LRV), as described above and was found to have an LRV of 35.82. This sample was calculated to have an inherent viscosity of 0.89 dL/g.

The sample underwent differential scanning calorimetry, (DSC), analysis. A recrystallization temperature was found on the programmed cool after the first heat cycle with an onset at 196.7° C. and a peak at 192.8° C., (55.6 J/g). A glass transition temperature, (Tg), was found with an onset temperature of 42.2° C., a midpoint temperature of 45.3° C., and an endpoint temperature of 48.4° C. A crystalline melting temperature, (Tm), was observed at 228.4° C., (52.3 J/g).

### Example 9

To a 500 milliliter glass flask was added bis(2-hydroxyethyl)terephthalate, (321.11 grams), Ketjenblack® EC 600 JD, (7.50 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.7 hours while under a slow nitrogen purge. After achieving 225° C., the resulting reaction mixture was stirred at 225° C. for 0.5 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.7 hours. 49.74 grams of a colorless distillate was collected over this heating cycle. The reaction mixture was then staged to full vacuum with stirring at 295° C. The resulting reaction mixture was stirred for 3.8 hours under full vacuum, (pressure less than 100 mtorr). The vacuum was then released with nitrogen and the reaction mass allowed to cool to room temperature. An additional 21.30 grams of distillate was recovered and 226.9 grams of a solid product was recovered.

The sample was found not to dissolve in the laboratory relative viscosity, (LRV), solvent system.

The sample underwent differential scanning calorimetry, (DSC), analysis. A recrystallization temperature was found on the programmed cool after the first heat cycle with an onset at 213.7° C. and a peak at 209.7° C., (52.0 J/g). A crystalline melting temperature, (Tm), was observed at 252.2° C., (64.1 J/g).

Surface resistivity was measured on pieces of the polymer produced above and were found to have a surface resistivity at the radius of 151 Ohms per square, a surface resistivity at the fracture of 69 Ohms per square, and a surface resistivity at the top of 77 Ohms per square.

### Example 10

To a 250 milliliter glass flask was added dimethyl terephthalate, (58.83 grams), dimethyl isophthalate, (39.34 grams), ethylene glycol, (62.39 grams), Ketjenblack® EC 600 JD, (3.07 grams), manganese(II) acetate tetrahydrate, (0.0446 grams), and antimony(III) trioxide, (0.0355 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.1 hours while under a slow nitrogen purge. After achieving 200° C., the resulting reaction mixture was stirred at 200° C. for 0.4 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.6 hours while under a slow nitrogen purge. The reaction mixture was heated to 295° C. over 0.7 hours with stirring under a slow nitrogen purge. The resulting reaction mixture was stirred at 295° C. under a slight nitrogen purge for 0.9 hours. 35.75 grams of a colorless distillate was collected over this heating cycle. The reaction mixture was then staged to full vacuum with stirring at 295° C. The resulting reaction mixture was stirred for 1.8 hours under full vacuum, (pressure less than 100 mtorr). The vacuum was then released with nitrogen and the reaction mass allowed to cool to room temperature. An additional 12.82 grams of distillate was recovered and 75.60 grams of a solid product was recovered.

The sample was measured for laboratory relative viscosity, (LRV), as described above and was found to have an LRV of 25.15. This sample was calculated to have an inherent viscosity of 0.70 dL/g.

The sample underwent differential scanning calorimetry, (DSC), analysis. A glass transition temperature, (Tg), was found with an onset temperature of 67.2° C. and an endpoint temperature of 71.4° C. A crystalline melting temperature, (Tm), was not observed.

### Example 11

To a 250 milliliter glass flask was added bis(2-hydroxyethyl)terephthalate, (127.78 grams), Ketjenblack® EC 600 JD, (3.50 grams), ethylene glycol, (25.00 grams), manganese(II) acetate tetrahydrate, (0.0437 grams), and antimony(III) trioxide, (0.0346 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.7 hours while under a slow nitrogen purge. The reaction mixture was heated to 295° C. over 0.4 hours with stirring under a slow nitrogen purge. The resulting reaction mixture was stirred at 295° C. under a slight nitrogen purge for 0.8 hours. 43.05 grams of a colorless distillate was collected over this heating cycle. The reaction mixture was then staged to full vacuum with stirring at 295° C. The resulting reaction mixture was stirred for 1.3 hours under full vacuum, (pressure less than 100 mtorr). The vacuum was then released with nitrogen and the reaction mass allowed to cool to room temperature. An additional 11.10 grams of distillate was recovered and 82.5 grams of a solid product was recovered.

The sample was measured for laboratory relative viscosity, (LRV), as described above and was found to have an LRV of 25.54. This sample was calculated to have an inherent viscosity of 0.71 dL/g.

The sample underwent differential scanning calorimetry, (DSC), analysis. A recrystallization temperature was found on the programmed cool after the first heat cycle with an onset at 210.9° C. and a peak at 205.8° C., (38.2 J/g). A glass transition temperature, (Tg), was found with an onset temperature of 74.7° C., a midpoint temperature of 78.4° C., and an endpoint temperature of 82.3° C. A crystalline melting temperature, (Tm), was observed at 248.0° C., (37.2 J/g).

### Example 12

To a 500 milliliter glass flask was added bis(2-hydroxyethyl)terephthalate, (319.46 grams), Ketjenblack® EC 600 JD, (8.75 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.5 hours while under a slow nitrogen purge. The reaction mixture was heated to 295° C. over 1.1 hours with stirring under a slow nitrogen purge. The resulting reaction mixture was stirred at 295° C. under a slight nitrogen purge for 0.7 hours. 32.79 grams of a colorless distillate was collected over this heating cycle. The reaction mixture was then staged to full vacuum with stirring at 295° C. The resulting reaction mixture was stirred for 4.1 hours under full vacuum, (pressure less than 100 mtorr). The vacuum was then released with nitrogen and the reaction mass allowed to cool to room temperature. An additional 40.10 grams of distillate was recovered and 224.7 grams of a solid product was recovered.

The sample was measured for laboratory relative viscosity, (LRV), as described above and was found to have an LRV of 9.71. This sample was calculated to have an inherent viscosity of 0.42 dL/g.

The sample underwent differential scanning calorimetry, (DSC), analysis. A recrystallization temperature was found on the programmed cool after the first heat cycle with an onset at 212.8° C. and a peak at 207.7 C, (45.5 J/g). A glass transition temperature, (Tg), was found with an onset temperature of 78.5° C., a midpoint temperature of 82.3° C., and an endpoint temperature of 85.8° C. A crystalline melting temperature, (Tm), was observed at 251.2° C., (44.0 J/g).

Surface resistivity was measured on pieces of the polymer produced above and were found to have a surface resistivity at the radius of 46 Ohms per square, a surface resistivity at the fracture of 61 Ohms per square, and a surface resistivity at the top of 59 Ohms per square.

### Example 13

To a 500 milliliter glass flask was added bis(2-hydroxyethyl)terephthalate, (317.80 grams), Ketjenblack® EC 600 JD, (10.00 grams), manganese(II) acetate tetrahydrate, (0.1117 grams), and antimony(III) trioxide, (0.0904 grams). The reaction mixture was stirred and heated to 200° C. under a slow nitrogen purge. After achieving 200° C., the resulting reaction mixture was stirred at 200° C. for 1.2 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.5 hours while under a slow nitrogen purge. The reaction mixture was heated to 295° C. over 0.6 hours with stirring under a slow nitrogen purge. The resulting reaction mixture was stirred at 295° C. under a slight nitrogen purge for 0.6 hours. 38.79 grams of a colorless distillate was collected over this heating cycle. The reaction mixture was then staged to full vacuum with stirring at 295° C. The resulting reaction mixture was stirred for 3.0 hours under full vacuum, (pressure less than 100 mtorr). The vacuum was then released with nitrogen and the reaction mass allowed to cool to room temperature. An additional 32.68 grams of distillate was recovered and 211.89 grams of a solid product was recovered.

The sample was measured for laboratory relative viscosity, (LRV), as described above and was found to have an LRV of 11.61. This sample was calculated to have an inherent viscosity of 0.46 dL/g.

The sample underwent differential scanning calorimetry, (DSC), analysis. A recrystallization temperature was found on the programmed cool after the first heat cycle with an onset at 213.8° C. and a peak at 208.8° C., (43.6 J/g). A glass transition temperature, (Tg), was found with an onset temperature of 69.6° C., a midpoint temperature of 76.8° C., and an endpoint temperature of 83.9 C. A crystalline melting temperature, (Tm), was observed at 250.6° C., (38.5 J/g).

Surface resistivity was measured on pieces of the polymer produced above and were found to have a surface resistivity at the fracture of 69 Ohms per square, and a surface resistivity at the top of 41 Ohms per square.

### Comparative Example CE1

To a 250 milliliter glass flask was added bis(2-hydroxyethyl)terephthalate, (125.80 grams), Ketjenblack® EC 600 JD, (5.00 grams), ethylene glycol, (25.00 grams), manganese(II) acetate tetrahydrate, (0.0461 grams), and antimony(III) trioxide, (0.0363 grams). The reaction mixture was stirred and heated to 180° C. under a slow nitrogen purge. After achieving 180 C, the resulting reaction mixture was stirred at 180° C. for 0.7 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.8 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.5 hours. The reaction mixture was a very thick black paste and stirring was not efficient. 33.42 grams of a colorless distillate was collected over this heating cycle. The reaction mixture was then staged to full vacuum with stirring at 295° C. The resulting reaction mixture solidified and could not be stirred. The solid black mass was continued to be heated at 295° C. for 3.1 hours under full vacuum, (pressure less than 100 mtorr). The vacuum was then released with nitrogen and the reaction mass allowed to cool to room temperature. An additional 21.78 grams of distillate was recovered and 88.7 grams of a solid product was recovered.

The sample was measured for laboratory relative viscosity, (LRV), as described above and was found to have an LRV of 27.07. This sample was calculated to have an inherent viscosity of 0.74 dL/g.

The sample underwent differential scanning calorimetry, (DSC), analysis. A recrystallization temperature was found on the programmed cool after the first heat cycle with an onset at 212.4° C. and a peak at 207.1° C., (36.4 J/g). A glass transition temperature, (Tg), was found with an onset temperature of 74.5 C, a midpoint temperature of 79.5° C., and an endpoint temperature of 84.5° C. A crystalline melting temperature, (Tm), was observed at 249.1° C., (37.3 J/g).

### Example 14

To a 250 milliliter glass flask was added dimethyl terephthalate, (91.91 grams), 1,3-propanediol, (46.82 grams), Printex® XE-2, (2.50 grams), and titanium(IV) isopropoxide, (0.128 grams). The reaction mixture was stirred and heated to 180° C. under a slow nitrogen purge. After achieving 180° C., the resulting reaction mixture was stirred at 180° C. for 0.3 hours while under a slow nitrogen purge. The reaction mixture was then stirred and heated to 190° C. over 0.1 hours while under a slow nitrogen purge. After achieving 190° C., the resulting reaction mixture was stirred at 190° C. for 0.4 hours while under a slow nitrogen purge. The reaction mixture was then stirred and heated to 200° C. over 0.1 hours while under a slow nitrogen purge. After achieving 200° C., the resulting reaction mixture was stirred at 200° C. for 0.4 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.5 hours while under a slow nitrogen purge. The reaction mixture was heated to 255° C. over 0.2 hours with stirring under a slow nitrogen purge. The resulting reaction mixture was stirred at 255° C. under a slight nitrogen purge for 0.9 hours. 20.02 grams of a colorless distillate was collected over this heating cycle. The reaction mixture was then staged to full vacuum with stirring at 255° C. The resulting reaction mixture was stirred for 0.9 hours under full vacuum, (pressure less than 100 mtorr). The vacuum was then released with nitrogen and the reaction mass allowed to cool to room temperature. An additional 4.52 grams of distillate was recovered and 89.7 grams of a solid product was recovered.

The sample was measured for laboratory relative viscosity, (LRV), as described above and was found to have an LRV of 32.65. This sample was calculated to have an inherent viscosity of 0.84 dL/g.

The sample underwent differential scanning calorimetry, (DSC), analysis. A recrystallization temperature was found on the programmed cool after the first heat cycle with an onset at 190.6° C. and a peak at 182.8 C, (50.8 J/g). A glass transition temperature, (Tg), was found with an onset temperature of 50.0 C, a midpoint temperature of 54.3° C., and an endpoint temperature of 58.6° C. A crystalline melting temperature, (Tm), was observed at 233.8° C., (48.1 J/g).

### Example 15

To a 500 milliliter glass flask was added bis(2-hydroxyethyl)terephthalate, (321.11 grams), Printex® XE-2, (7.50 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.7 hours. 50.92 grams of a colorless distillate was collected over this heating cycle. The reaction mixture was then staged to full vacuum with stirring at 295° C. The resulting reaction mixture was stirred for 4.1 hours under full vacuum, (pressure less than 100 mtorr). The vacuum was then released with nitrogen and the reaction mass allowed to cool to room temperature. An additional 12.50 grams of distillate was recovered and 229.7 grams of a solid product was recovered.

The sample was measured for laboratory relative viscosity, (LRV), as described above and was found to have an LRV of 17.73. This sample was calculated to have an inherent viscosity of 0.57 dL/g.

The sample underwent differential scanning calorimetry, (DSC), analysis. A recrystallization temperature was found on the programmed cool after the first heat cycle with an onset at 212.4° C. and a peak at 207.0° C., (45.8 J/g). A glass transition temperature, (Tg), was found with an onset temperature of 78.8° C., a midpoint temperature of 79.4° C., and an endpoint temperature of 80.0° C. A crystalline melting temperature, (Tm), was observed at 247.9° C., (45.4 J/g).

Surface resistivity was measured on pieces of the polymer produced above and were found to have a surface resistivity at the radius of 16,472 Ohms per square, a surface resistivity at the fracture of 3,696 Ohms per square, and a surface resistivity at the top of 58,400 Ohms per square.

### Example 16

To a 500 milliliter glass flask was added bis(2-hydroxyethyl)terephthalate, (321.11 grams), Printex® XE-2, (7.50 grams), manganese(II) acetate tetrahydrate, (0.1118 grams), and antimony(III) trioxide, (0.0897 grams). The reaction mixture was stirred and heated to 180° C. under a slow nitrogen purge. After achieving 180° C., the resulting reaction mixture was stirred at 180° C. for 0.3 hours while under a slow nitrogen purge. The reaction mixture was then stirred and heated to 225° C. over 1.3 hours while under a slow nitrogen purge. After achieving 225° C., the resulting reaction mixture was stirred at 225° C. for 1.0 hour while under a slow nitrogen purge. The reaction mixture was heated to 295° C. over 1.2 hours with stirring under a slow nitrogen purge. The resulting reaction mixture was stirred at 295° C. under a slight nitrogen purge for 0.4 hours. 49.80 grams of a colorless distillate was collected over this heating cycle. The reaction mixture was then staged to full vacuum with stirring at 295° C. The resulting reaction mixture was stirred for 3.2 hours under full vacuum, (pressure less than 100 mtorr). The vacuum was then released with nitrogen and the reaction mass allowed to cool to room temperature. An additional 23.66 grams of distillate was recovered and 246.67 grams of a solid product was recovered.

The sample was measured for laboratory relative viscosity, (LRV), as described above and was found to have an LRV of 8.63. This sample was calculated to have an inherent viscosity of 0.40 dL/g.

The sample underwent differential scanning calorimetry, (DSC), analysis. A recrystallization temperature was found on the programmed cool after the first heat cycle with an onset at 218.4° C. and a peak at 213.9° C., (48.2 J/g). A glass transition temperature, (Tg), was found with an onset temperature of 72.7° C., a midpoint temperature of 79.4° C., and an endpoint temperature of 85.9° C. A crystalline melting temperature, (Tm), was observed at 249.5° C., (44.1 J/g).

### Example 17

To a 1 liter glass flask was added bis(2-hydroxyethyl)terephthalate, (321.11 grams), a ball milled dispersion of 5.88 weight percent Printex® XE-2 and 0.7 weight percent of poly(vinyl pyrrolidone) in ethylene glycol, (127.55 grams, provided as Aquablak® 6024 from Solutions Dispersions, Inc.), ethylene glycol, (6.60 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.5 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.5 hours. 183.41 grams of a colorless distillate was collected over this heating cycle. The reaction mixture was then staged to full vacuum with stirring at 295° C. The resulting reaction mixture was stirred for 2.2 hours under full vacuum, (pressure less than 100 mtorr). The vacuum was then released with nitrogen and the reaction mass allowed to cool to room temperature. An additional 6.00 grams of distillate was recovered and 235.0 grams of a solid product was recovered.

The sample was measured for laboratory relative viscosity, (LRV), as described above and was found to have an LRV of 20.89. This sample was calculated to have an inherent viscosity of 0.62 dL/g.

The sample underwent differential scanning calorimetry, (DSC), analysis. A recrystallization temperature was found on the programmed cool after the first heat cycle with an onset at 203.5° C. and a peak at 197.00° C., (37.7 J/g). A glass transition temperature, (Tg), was found with an onset temperature of 71.4° C., a midpoint temperature of 73.9° C., and an endpoint temperature of 75.5° C. A crystalline melting temperature, (Tm), was observed at 240.1°.

Surface resistivity was measured on pieces of the polymer produced above and were found to have a surface resistivity at the fracture of 453 Ohms per square, and a surface resistivity at the top of 2,061 Ohms per square.

### Example 18

To a 500 milliliter glass flask was added bis(2-hydroxyethyl)terephthalate, (319.46 grams), Printex® XE-2, (8.75 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.6 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.7 hours. 53.81 grams of a colorless distillate was collected over this heating cycle. The reaction mixture was then staged to full vacuum with stirring at 295° C. The resulting reaction mixture was stirred for 4.1 hours under full vacuum, (pressure less than 100 mtorr). The vacuum was then released with nitrogen and the reaction mass allowed to cool to room temperature. An additional 19.30 grams of distillate was recovered and 221.6 grams of a solid product was recovered.

The sample was measured for laboratory relative viscosity, (LRV), as described above and was found to have an LRV of 19.11. This sample was calculated to have an inherent viscosity of 0.59 dL/g.

The sample underwent differential scanning calorimetry, (DSC), analysis. A recrystallization temperature was found on the programmed cool after the first heat cycle with an onset at 213.4° C. and a peak at 208.1° C., (46.6 J/g). A glass transition temperature, (Tg), was found with an onset temperature of 78.4° C., a midpoint temperature of 78.5° C., and an endpoint temperature of 79.0° C. A crystalline melting temperature, (Tm), was observed at 248.8° C., (44.6 J/g).

Surface resistivity was measured on pieces of the polymer produced above and were found to have a surface resistivity at the fracture of 188 Ohms per square, and a surface resistivity at the top of 269 Ohms per square.

### Example 19

To a 500 milliliter glass flask was added bis(2-hydroxyethyl)terephthalate, (317.80 grams), Printex® XE-2, (10.00 grams), manganese(II) acetate tetrahydrate, (0.1108 grams), and antimony(III) trioxide, (0.0895 grams). The reaction mixture was stirred and heated to 200° C. under a slow nitrogen purge. After achieving 200° C., the resulting reaction mixture was stirred at 200° C. for 0.5 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.5 hours while under a slow nitrogen purge. The reaction mixture was heated to 295° C. over 0.5 hours with stirring under a slow nitrogen purge. The resulting reaction mixture was stirred at 295° C. under a slight nitrogen purge for 0.6 hours. 48.32 grams of a colorless distillate was collected over this heating cycle. The reaction mixture was then staged to full vacuum with stirring at 295° C. The resulting reaction mixture was stirred for 3.5 hours under full vacuum, (pressure less than 100 mtorr). The vacuum was then released with nitrogen and the reaction mass allowed to cool to room temperature. An additional 23.01 grams of distillate was recovered and 249.0 grams of a solid product was recovered.

The sample was measured for laboratory relative viscosity, (LRV), as described above and was found to have an LRV of 23.03. This sample was calculated to have an inherent viscosity of 0.66 dL/g.

The sample underwent differential scanning calorimetry, (DSC), analysis. A recrystallization temperature was found on the programmed cool after the first heat cycle with an onset at 218.2° C. and a peak at 214.0° C., (43.0 J/g). A glass transition temperature, (Tg), was found with an onset temperature of 70.9° C., a midpoint temperature of 76.2° C., and an endpoint temperature of 81.5° C. A crystalline melting temperature, (Tm), was observed at 251.3° C., (42.3 J/g).

Surface resistivity was measured on pieces of the polymer produced above and were found to have a surface resistivity at the radius of 105 Ohms per square, and a surface resistivity at the fracture of 101 Ohms per square.

### Example 20

To a 250 milliliter glass flask was added dimethyl terephthalate, (85.43 grams), ethylene glycol, (37.24 grams), 1,4-cyclohexanedimethanol, (20.18 grams), Printex® XE-2, (4.00 grams), manganese(II) acetate tetrahydrate, (0.0446 grams), and antimony(III) trioxide, (0.0359 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.2 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.6 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.5 hours. 26.88 grams of a colorless distillate was collected over this heating cycle. The reaction mixture was then staged to full vacuum with stirring at 295° C. The resulting reaction mixture was stirred for 2.4 hours under full vacuum, (pressure less than 100 mtorr). The vacuum was then released with nitrogen and the reaction mass allowed to cool to room temperature. An additional 10.00 grams of distillate was recovered and 99.80 grams of a solid product was recovered.

The sample was measured for laboratory relative viscosity, (LRV), as described above and was found to have an LRV of 15.65. This sample was calculated to have an inherent viscosity of 0.53 dL/g.

The sample underwent differential scanning calorimetry, (DSC), analysis. A glass transition temperature, (Tg), was found with an onset temperature of 77.4° C., a midpoint temperature of 79.3° C., and an endpoint temperature of 81.3° C. A broad crystalline melting temperature, (Tm), was observed at a temperature of 173.3° C., (0.6 J/g).

### Example 21

To a 500 milliliter glass flask was added bis(2-hydroxyethyl)terephthalate, (314.49 grams), Printex® XE-2, (12.50 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.7 hours. 48.58 grams of a colorless distillate was collected over this heating cycle. The reaction mixture was then staged to full vacuum with stirring at 295° C. The resulting reaction mixture was stirred for 2.9 hours under full vacuum, (pressure less than 100 mtorr). The vacuum was then released with nitrogen and the reaction mass allowed to cool to room temperature. An additional 24.60 grams of distillate was recovered and 240.0 grams of a solid product was recovered.

The sample was found not to dissolve in the laboratory relative viscosity, (LRV), solvent system.

The sample underwent differential scanning calorimetry, (DSC), analysis. A recrystallization temperature was found on the programmed cool after the first heat cycle with an onset at 217.7° C. and a peak at 213.2° C., (515 J/g). A glass transition temperature, (Tg), was found with an onset temperature of 69.5° C., a midpoint temperature of 70.1° C., and an endpoint temperature of 71.2° C. A crystalline melting temperature, (Tm), was observed at 251.9° C., (52.6 J/g).

Surface resistivity was measured on pieces of the polymer produced above and were found to have a surface resistivity at the radius of 48 Ohms per square, a surface resistivity at the fracture of 44 Ohms per square, and a surface resistivity at the top of 44 Ohms per square.

### Example 22

To a 250 milliliter glass flask was added bis(2-hydroxyethyl)terephthalate, (202.2 grams), ethylene glycol, (53.0 grams), Printex® XE-2, (8.1 grams), manganese(II) acetate tetrahydrate, (0.07 grams), and antimony(III) trioxide, (0.054 grams). The reaction mixture was stirred and heated to 180° C. under a slow nitrogen purge. After achieving 180° C., the resulting reaction mixture was stirred at 180° C. for 0.3 hours while under a slow nitrogen purge. The reaction mixture was heated to 285° C. over 0.6 hours with stirring under a slow nitrogen purge. The resulting reaction mixture was stirred at 285° C. under a slight nitrogen purge for 1.0 hour. 86.19 grams of a colorless distillate was collected over this heating cycle. The reaction mixture was then staged to full vacuum with stirring at 285° C. The resulting reaction mixture was stirred for 1.1 hours under full vacuum, (pressure less than 100 mtorr). The vacuum was then released with nitrogen and the reaction mass allowed to cool to room temperature. An additional 18.70 grams of distillate was recovered and 143.8 grams of a solid product was recovered.

The sample was measured for laboratory relative viscosity, (LRV), as described above and was found to have an LRV of 12.15. This sample was calculated to have an inherent viscosity of 0.47 dL/g.

The sample underwent differential scanning calorimetry, (DSC), analysis. A recrystallization temperature was found on the programmed cool after the first heat cycle with an onset at 219.4° C. and a peak at 214.9° C., (42.5 J/g). A glass transition temperature, (Tg), was found with an onset temperature of 70.1° C., a midpoint temperature of 74.3° C., and an endpoint temperature of 79.7° C. A crystalline melting temperature, (Tm), was observed at 254.1° C., (44.5 J/g).

### Comparative Example CE2

To a 250 milliliter glass flask was added bis(2-hydroxyethyl)terephthalate, (119.18 grams), Printex® XE-2, (10.00 grams), ethylene glycol, (25.00 grams), manganese(II) acetate tetrahydrate, (0.0453 grams), and antimony(III) trioxide, (0.0366 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.8 hours while under a slow nitrogen purge. The reaction mixture had solidified to a dry, black paste and was not stirring. The reaction mixture was heated to 285° C. over 0.7 hours under a slow nitrogen purge. The resulting reaction mixture was held at 285° C. under a slight nitrogen purge for 0.5 hours. 16.34 grams of a colorless distillate was collected over this heating cycle. The reaction mixture was then staged to full vacuum at 285° C. The resulting reaction mixture was held for 2.6 hours under full vacuum, (pressure less than 100 mtorr). The vacuum was then released with nitrogen and the reaction mass allowed to cool to room temperature. An additional 32.60 grams of distillate was recovered and 85.0 grams of a solid product was recovered.

The sample was measured for laboratory relative viscosity, (LRV), as described above and was found to have an LRV of 3.07. This sample was calculated to have an inherent viscosity of 0.30 dL/g.

The sample underwent differential scanning calorimetry, (DSC), analysis. A recrystallization temperature was found on the programmed cool after the first heat cycle with an onset at 220.3° C. and a peak at 214.7° C., (42.3 J/g). A glass transition temperature, (Tg), was found with an onset temperature of 71.9° C., a midpoint temperature of 79.0° C., and an endpoint temperature of 86.0° C. A crystalline melting temperature, (Tm), was observed at 249.0° C., (42.7 J/g).

### Example 23

To a 250 milliliter glass flask was added dimethyl terephthalate, (58.86 grams), dimethyl isophthalate, (39.24 grams), ethylene glycol, (62.72 grams), Ketjenblack® EC 300 J, (3.00 grams), manganese(II) acetate tetrahydrate, (0.0446 grams), and antimony(III) trioxide, (0.0359 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.6 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.5 hours while under a slow nitrogen purge. The reaction mixture was heated to 295° C. over 0.7 hours with stirring under a slow nitrogen purge. The resulting reaction mixture was stirred at 295° C. under a slight nitrogen purge for 0.5 hours. 39.86 grams of a colorless distillate was collected over this heating cycle. The reaction mixture was then staged to full vacuum with stirring at 295° C. The resulting reaction mixture was stirred for 1.8 hours under full vacuum, (pressure less than 100 mtorr). The vacuum was then released with nitrogen and the reaction mass allowed to cool to room temperature. An additional 13.60 grams of distillate was recovered and 97.7 grams of a solid product was recovered.

The sample was measured for laboratory relative viscosity, (LRV), as described above and was found to have an LRV of 26.87. This sample was calculated to have an inherent viscosity of 0.73 dL/g.

The sample underwent differential scanning calorimetry, (DSC), analysis. A glass transition temperature, (Tg), was found with an onset temperature of 66.5° C., a midpoint temperature of 68.5° C., and an endpoint temperature of 70.8° C. A crystalline melting temperature, (Tm), was not observed.

### Example 24

To a 500 milliliter glass flask was added bis(2-hydroxyethyl)terephthalate, (319.46 grams), Ketjenblack® EC 300 J, (8.75 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.5 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.9 hours. 47.91 grams of a colorless distillate was collected over this heating cycle. The reaction mixture was then staged to full vacuum with stirring at 295° C. The resulting reaction mixture was stirred for 3.6 hours under full vacuum, (pressure less than 100 mtorr). The vacuum was then released with nitrogen and the reaction mass allowed to cool to room temperature. An additional 21.30 grams of distillate was recovered and 233.9 grams of a solid product was recovered.

The sample was measured for laboratory relative viscosity, (LRV), as described above and was found to have an LRV of 10.12. This sample was calculated to have an inherent viscosity of 0.43 dL/g.

The sample underwent differential scanning calorimetry, (DSC), analysis. A recrystallization temperature was found on the programmed cool after the first heat cycle with an onset at 215.4° C. and a peak at 210.6° C., (46.8 J/g). A glass transition temperature, (Tg), was found with an onset temperature of 72.7° C., a midpoint temperature of 77.6° C., and an endpoint temperature of 82.6° C. A crystalline melting temperature, (Tm), was observed at 250.9° C., (48.1 J/g).

Surface resistivity was measured on pieces of the polymer produced above and were found to have a surface resistivity at the radius of 129 Ohms per square and a surface resistivity at the fracture of 124 Ohms per square.

### Example 25

To a 500 milliliter glass flask was added bis(2-hydroxyethyl)terephthalate, (317.80 grams), Ketjenblack® EC 300 J, (10.00 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.7 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.6 hours. 46.03 grams of a colorless distillate was collected over this heating cycle. The reaction mixture was then staged to full vacuum with stirring at 295° C. The resulting reaction mixture was stirred for 4.4 hours under full vacuum, (pressure less than 100 mtorr). The vacuum was then released with nitrogen and the reaction mass allowed to cool to room temperature. An additional 27.40 grams of distillate was recovered and 226.9 grams of a solid product was recovered.

The sample was measured for laboratory relative viscosity, (LRV), as described above and was found to have an LRV of 14.96. This sample was calculated to have an inherent viscosity of 0.52 dL/g.

The sample underwent differential scanning calorimetry, (DSC), analysis. A recrystallization temperature was found on the programmed cool after the first heat cycle with an onset at 213.1° C. and a peak at 207.9° C., (45.7 J/g). A glass transition temperature, (Tg), was found with an onset temperature of 75.5° C., a midpoint temperature of 79.6° C., and an endpoint temperature of 83.9° C. A crystalline melting temperature, (Tm), was observed at 248.6° C., (38.5 J/g).

Surface resistivity was measured on pieces of the polymer produced above and were found to have a surface resistivity at the radius of 114 Ohms per square and a surface resistivity at the fracture of 64 Ohms per square.

### Example 26

To a 500 milliliter glass flask was added bis(2-hydroxyethyl)terephthalate, (314.49 grams), Ketjenblack® EC 300 J, (12.5 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 0.7 hours with stirring under a slow nitrogen purge. The resulting reaction mixture was stirred at 295° C. under a slight nitrogen purge for 0.8 hours. 41.01 grams of a colorless distillate was collected over this heating cycle. The reaction mixture was then staged to full vacuum with stirring at 295° C. The resulting reaction mixture was stirred for 4.0 hours under full vacuum, (pressure less than 100 mtorr). The vacuum was then released with nitrogen and the reaction mass allowed to cool to room temperature. An additional 32.90 grams of distillate was recovered and 232.3 grams of a solid product was recovered.

The sample was measured for laboratory relative viscosity, (LRV), as described above and was found to have an LRV of 12.25. This sample was calculated to have an inherent viscosity of 0.47 dL/g.

The sample underwent differential scanning calorimetry, (DSC), analysis. A recrystallization temperature was found on the programmed cool after the first heat cycle with an onset at 215.4° C. and a peak at 209.9° C., (50.8 J/g). A glass transition temperature, (Tg), was found with an onset temperature of 73.3° C., a midpoint temperature of 77.9° C., and an endpoint temperature of 82.9° C. A crystalline melting temperature, (Tm), was observed at 251.0° C., (43.3 J/g).

Surface resistivity was measured on pieces of the polymer produced above and were found to have a surface resistivity at the radius of 64 Ohms per square and a surface resistivity at the fracture of 67 Ohms per square.

### Example 27

To a 1 liter glass flask was added bis(2-hydroxyethyl)terephthalate, (314.49 grams), a ball milled dispersion containing 8.00 weight percent Ketjenblack® EC 300 J and 0.7 weight percent poly(vinyl pyrrolidine) in ethylene glycol, (156.25 grams, provided as Aquablak® 6071 from Solution Dispersions, Inc.), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.6 hours while under a slow nitrogen purge. The reaction mixture was heated to 295° C. over 1.1 hours with stirring under a slow nitrogen purge. The resulting reaction mixture was stirred at 295° C. under a slight nitrogen purge for 0.8 hours. 185.78 grams of a colorless distillate was collected over this heating cycle. The reaction mixture was then staged to full vacuum with stirring at 295° C. The resulting reaction mixture was stirred for 4.0 hours under full vacuum, (pressure less than 100 mtorr). The vacuum was then released with nitrogen and the reaction mass allowed to cool to room temperature. An additional 21.90 grams of distillate was recovered and 228.3 grams of a solid product was recovered.

The sample was measured for laboratory relative viscosity, (LRV), as described above and was found to have an LRV of 12.16. This sample was calculated to have an inherent viscosity of 0.47 dL/g.

The sample underwent differential scanning calorimetry, (DSC), analysis. A recrystallization temperature was found on the programmed cool after the first heat cycle with an onset at 213.2° C. and a peak at 208.3° C., (45.2 J/g). A glass transition temperature, (Tg), was found with an onset temperature of 74.8° C., a midpoint temperature of 77.1° C., and an endpoint temperature of 79.3° C. A crystalline melting temperature, (Tm), was observed at 248.2° C., (45.5 J/g).

### Example 28

To a 250 milliliter glass flask was added dimethyl terephthalate, (83.89 grams), 1,4-butanediol, (50.63 grams), Ketjenblack® EC 300 J, (5.10 grams), and titanium(IV) isopropoxide, (0.1240 grams). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 190° C. over 0.1 hours while under a slow nitrogen purge. After achieving 190° C., the resulting reaction mixture was stirred at 190° C. for 0.7 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.5 hours while under a slow nitrogen purge. The reaction mixture was heated to 255° C. over 0.7 hours with stirring under a slow nitrogen purge. The resulting reaction mixture was stirred at 255° C. under a slight nitrogen purge for 0.8 hours. 18.09 grams of a colorless distillate was collected over this heating cycle. The reaction mixture was then staged to full vacuum with stirring at 255° C. The resulting reaction mixture was stirred for 1.7 hours under full vacuum, (pressure less than 100 mtorr). The vacuum was then released with nitrogen and the reaction mass allowed to cool to room temperature. An additional 5.29 grams of distillate was recovered and 92.8 grams of a solid product was recovered.

The sample was measured for laboratory relative viscosity, (LRV), as described above and was found to have an LRV of 25.21. This sample was calculated to have an inherent viscosity of 0.70 dL/g.

The sample underwent differential scanning calorimetry, (DSC), analysis. A recrystallization temperature was found on the programmed cool after the first heat cycle with an onset at 198.7° C. and a peak at 193.4° C., (31.2 J/g). A crystalline melting temperature, (Tm), was observed at 229.8° C., (31.2 J/g).

### Example 29

To a 500 milliliter glass flask was added bis(2-hydroxyethyl)terephthalate, (314.49 grams), Vulcan® XC72, (12.50 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.7 hours while under a slow nitrogen purge. After achieving 225° C., the resulting reaction mixture was stirred at 225° C. for 0.5 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.6 hours. 52.21 grams of a colorless distillate was collected over this heating cycle. The reaction mixture was then staged to full vacuum with stirring at 295° C. The resulting reaction mixture was stirred for 4.3 hours under full vacuum, (pressure less than 100 mtorr). The vacuum was then released with nitrogen and the reaction mass allowed to cool to room temperature. An additional 25.30 grams of distillate was recovered and 242.0 grams of a solid product was recovered.

The sample was measured for laboratory relative viscosity, (LRV), as described above and was found to have an LRV of 14.04. This sample was calculated to have an inherent viscosity of 0.50 dL/g.

The sample underwent differential scanning calorimetry, (DSC), analysis. A recrystallization temperature was found on the programmed cool after the first heat cycle with an onset at 210.8° C. and a peak at 206.8° C., (44.5 J/g). A glass transition temperature, (Tg), was found with an onset temperature of 75.8° C., a midpoint temperature of 78.5° C., and an endpoint temperature of 81.8° C. A crystalline melting temperature, (Tm), was observed at 247.4° C., (47.2 J/g).

### Example 30

To a 250 milliliter glass flask was added dimethyl terephthalate, (88.66 grams), 1,3-propanediol, (45.19 grams), Vulcan® XC-72, (6.00 grams), and titanium(IV) isopropoxide, (0.1290 grams). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 200° C. over 0.2 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.5 hours while under a slow nitrogen purge. After achieving 225° C., the resulting reaction mixture was stirred at 225° C. for 1.2 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.8 hours. 18.87 grams of a colorless distillate was collected over this heating cycle. The reaction mixture was then staged to full vacuum with stirring at 255° C. The resulting reaction mixture was stirred for 0.9 hours under full vacuum, (pressure less than 100 mtorr). The vacuum was then released with nitrogen and the reaction mass allowed to cool to room temperature. An additional 4.95 grams of distillate was recovered and 87.9 grams of a solid product was recovered. The sample was measured for laboratory relative viscosity, (LRV), as described above and was found to have an LRV of 42.86. This sample was calculated to have an inherent viscosity of 1.02 dL/g.

The sample underwent differential scanning calorimetry, (DSC), analysis. A recrystallization temperature was found on the programmed cool after the first heat cycle with an onset at 178.1° C. and a peak at 164.7° C., (46.2 J/g). A glass transition temperature, (Tg), was found with an onset temperature of 44.1 C, a midpoint temperature of 49.2° C., and an endpoint temperature of 54.4° C. A crystalline melting temperature, (Tm), was observed at 229.6° C., (47.2 J/g).

### Example 31

To a 250 milliliter glass flask was added dimethyl terephthalate, (56.44 grams), dimethyl isophthalate, (37.62 grams), ethylene glycol, (60.13 grams), Vulcan® XC-72, (7.00 grams), manganese(II) acetate tetrahydrate, (0.0446 grams), and antimony(III) trioxide, (0.0359 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.6 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.6 hours while under a slow nitrogen purge. The reaction mixture was heated to 295° C. over 0.7 hours with stirring under a slow nitrogen purge. The resulting reaction mixture was stirred at 295° C. under a slight nitrogen purge for 0.4 hours. 38.36 grams of a colorless distillate was collected over this heating cycle. The reaction mixture was then staged to full vacuum with stirring at 295° C. The resulting reaction mixture was stirred for 2.8 hours under full vacuum, (pressure less than 100 mtorr). The vacuum was then released with nitrogen and the reaction mass allowed to cool to room temperature. An additional 10.20 grams of distillate was recovered and 96.6 grams of a solid product was recovered.

The sample was measured for laboratory relative viscosity, (LRV), as described above and was found to have an LRV of 24.89. This sample was calculated to have an inherent viscosity of 0.70 dL/g.

The sample underwent differential scanning calorimetry, (DSC), analysis. A glass transition temperature, (Tg), was found with an onset temperature of 65.7° C., a midpoint temperature of 67.7° C., and an endpoint temperature of 69.7° C. A crystalline melting temperature, (Tm), was not observed.

### Example 32

To a 500 milliliter glass flask was added bis(2-hydroxyethyl)terephthalate, (306.21 grams), Vulcan® XC72, (18.75 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.5 hours while under a slow nitrogen purge. The reaction mixture was heated to 255° C. over 0.5 hours with stirring under a slow nitrogen purge. The resulting reaction mixture was stirred at 255° C. under a slight nitrogen purge for 0.6 hours. 31.84 grams of a colorless distillate was collected over this heating cycle. The reaction mixture was then staged to full vacuum with stirring at 255° C. The resulting reaction mixture was stirred for 3.3 hours under full vacuum, (pressure less than 100 mtorr). The vacuum was then released with nitrogen and the reaction mass allowed to cool to room temperature. An additional 34.10 grams of distillate was recovered and 223.9 grams of a solid product was recovered.

The sample was measured for laboratory relative viscosity, (LRV), as described above and was found to have an LRV of 5.24. This sample was calculated to have an inherent viscosity of 0.34 dL/g.

The sample underwent differential scanning calorimetry, (DSC), analysis. A recrystallization temperature was found on the programmed cool after the first heat cycle with an onset at 223.2° C. and a peak at 220.2° C., (63.3 J/g). A crystalline melting temperature, (Tm), was observed at 257.0° C., (58.8 J/g).

### Example 33

To a 500 milliliter glass flask was added bis(2-hydroxyethyl)terephthalate, (306.21 grams), Vulcan® XC72, (18.75 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.6 hours. 50.62 grams of a colorless distillate was collected over this heating cycle. The reaction mixture was then staged to full vacuum with stirring at 295° C. The resulting reaction mixture was stirred for 2.6 hours under full vacuum, (pressure less than 100 mtorr). The vacuum was then released with nitrogen and the reaction mass allowed to cool to room temperature. An additional 16.0 grams of distillate was recovered and 223.4 grams of a solid product was recovered.

The sample was measured for laboratory relative viscosity, (LRV), as described above and was found to have an LRV of 16.56. This sample was calculated to have an inherent viscosity of 0.55 dL/g.

The sample underwent differential scanning calorimetry, (DSC), analysis. A recrystallization temperature was found on the programmed cool after the first heat cycle with an onset at 209.6° C. and a peak at 205.4° C., (43.3 J/g). A glass transition temperature, (Tg), was found with an onset temperature of 76.7° C., a midpoint temperature of 79.0° C., and an endpoint temperature of 81.9° C. A crystalline melting temperature, (Tm), was observed at 247.3° C., (43.7 J/g).

Surface resistivity was measured on pieces of the polymer produced above and were found to have a surface resistivity at the radius of 2,859 Ohms per square, and a surface resistivity at the fracture of 555 Ohms per square.

### Example 34

To a 1 liter glass flask was added bis(2-hydroxyethyl)terephthalate, (306.21 grams), a ball milled dispersion of 10.88 weight percent Vulcan® XC72 and 0.7 weight percent poly(vinyl pyrrolidone) in ethylene glycol (172.33 grams, provided as Aquablak® 6027 by Solution Dispersions, Inc.), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.6 hours. 190.96 grams of a colorless distillate was collected over this heating cycle. The reaction mixture was then staged to full vacuum with stirring at 295° C. The resulting reaction mixture was stirred for 2.3 hours under full vacuum, (pressure less than 100 mtorr). The vacuum was then released with nitrogen and the reaction mass allowed to cool to room temperature. An additional 21.2 grams of distillate was recovered and 239.7 grams of a solid product was recovered.

The sample was measured for laboratory relative viscosity, (LRV), as described above and was found to have an LRV of 25.49. This sample was calculated to have an inherent viscosity of 0.71 dL/g.

The sample underwent differential scanning calorimetry, (DSC), analysis. A recrystallization temperature was found on the programmed cool after the first heat cycle with an onset at 198.2° C. and a peak at 192.8° C., (39.1 J/g). A glass transition temperature, (Tg), was found with an onset temperature of 72.2° C., a midpoint temperature of 74.9° C., and an endpoint temperature of 77.7° C. A crystalline melting temperature, (Tm), was observed at 238.1° C., (35.8 J/g).

Surface resistivity was measured on pieces of the polymer produced above and were found to have a surface resistivity at the fracture of 274 Ohms per square, and a surface resistivity at the top of 1,056 Ohms per square.

### Example 35

To a 250 milliliter glass flask was added dimethyl terephthalate, (80.32 grams), 1,4-butanediol, (48.46 grams), Vulcan® XC-72, (9.00 grams), and titanium(IV) isopropoxide, (0.1188 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200 C over 0.3 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.6 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.5 hours. 20.8 grams of a colorless distillate was collected over this heating cycle. The reaction mixture was then staged to full vacuum with stirring at 255° C. The resulting reaction mixture was stirred for 1.1 hours under full vacuum, (pressure less than 100 mtorr). The vacuum was then released with nitrogen and the reaction mass allowed to cool to room temperature. An additional 1.50 grams of distillate was recovered and 95.3 grams of a solid product was recovered.

The sample was measured for laboratory relative viscosity, (LRV), as described above and was found to have an LRV of 34.63. This sample was calculated to have an inherent viscosity of 0.87 dL/g.

The sample underwent differential scanning calorimetry, (DSC), analysis. A recrystallization temperature was found on the programmed cool after the first heat cycle with an onset at 194.8° C. and a peak at 190.7° C., (48.8 J/g). A crystalline melting temperature, (Tm), was observed at 227.5° C., (55.1 J/g).

### Example 36

To a 500 milliliter glass flask was added bis(2-hydroxyethyl)terephthalate, (297.94 grams), Vulcan® XC72, (25.00 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.7 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.7 hours. 45.22 grams of a colorless distillate was collected over this heating cycle. The reaction mixture was then staged to full vacuum with stirring at 295° C. The resulting reaction mixture was stirred for 4.1 hours under full vacuum, (pressure less than 100 mtorr). The vacuum was then released with nitrogen and the reaction mass allowed to cool to room temperature. An additional 25.4 grams of distillate was recovered and 241.0 grams of a solid product was recovered.

The sample was measured for laboratory relative viscosity, (LRV), as described above and was found to have an LRV of 11.35. This sample was calculated to have an inherent viscosity of 0.45 dL/g.

The sample underwent differential scanning calorimetry, (DSC), analysis. A recrystallization temperature was found on the programmed cool after the first heat cycle with an onset at 212.3° C. and a peak at 208.0° C., (45.7 J/g). A glass transition temperature, (Tg), was found with an onset temperature of 72.7° C., a midpoint temperature of 78.1° C., and an endpoint temperature of 83.5° C. A crystalline melting temperature, (Tm), was observed at 249.8° C., (42.8 J/g).

Surface resistivity was measured on pieces of the polymer produced above and were found to have a surface resistivity at the radius of 48 Ohms per square and a surface resistivity at the fracture of 40 Ohms per square.

### Example 37

To a 250 milliliter glass flask was added dimethyl terephthalate, (80.04 grams), ethylene glycol, (34.98 grams), 1,4-cyclohexanedimethanol, (19.36 grams), Vulcan® XC-72, (10.40 grams), manganese(II) acetate tetrahydrate, (0.0468 grams), and antimony(III) trioxide, (0.0360 grams). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 200° C. over 0.2 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.1 hours while under a slow nitrogen purge. After achieving 225° C., the resulting reaction mixture was stirred at 225° C. for 1.0 hour while under a slow nitrogen purge. The reaction mixture was heated to 295° C. over 0.6 hours with stirring under a slow nitrogen purge. The resulting reaction mixture was stirred at 295° C. under a slight nitrogen purge for 0.8 hours. 20.86 grams of a colorless distillate was collected over this heating cycle. The reaction mixture was then staged to full vacuum with stirring at 295° C. The resulting reaction mixture was stirred for 0.6 hours under full vacuum, (pressure less than 100 mtorr). The vacuum was then released with nitrogen and the reaction mass allowed to cool to room temperature. An additional 6.87 grams of distillate was recovered and 92.2 grams of a solid product was recovered.

The sample was measured for laboratory relative viscosity, (LRV), as described above and was found to have an LRV of 18.01. This sample was calculated to have an inherent viscosity of 0.57 dL/g.

The sample underwent differential scanning calorimetry, (DSC), analysis. A glass transition temperature, (Tg), was found with an onset temperature of 74.9° C. and an endpoint temperature of 79.7° C. A broad crystalline melting temperature, (Tm), was observed at a temperature of 172.3° C., (0.9 J/g).

### Example 38

To a 500 milliliter glass flask was added bis(2-hydroxyethyl)terephthalate, (289.66 grams), Vulcan® XC72, (31.25 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.7 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.6 hours. 43.09 grams of a colorless distillate was collected over this heating cycle. The reaction mixture was then staged to full vacuum with stirring at 295° C. The resulting reaction mixture was stirred for 4.3 hours under full vacuum, (pressure less than 100 mtorr). The vacuum was then released with nitrogen and the reaction mass allowed to cool to room temperature. An additional 23.90 grams of distillate was recovered and 236.7 grams of a solid product was recovered.

The sample was not found to be soluble in the laboratory relative viscosity, (LRV), solvent system.

The sample underwent differential scanning calorimetry, (DSC), analysis. A recrystallization temperature was found on the programmed cool after the first heat cycle with an onset at 210.5° C. and a peak at 205.7° C., (43.0 J/g). A glass transition temperature, (Tg), was found with an onset temperature of 74.3° C., a midpoint temperature of 75.7° C., and an endpoint temperature of 77.2° C. A crystalline melting temperature, (Tm), was observed at 246.7° C., (39.9 J/g).

Surface resistivity was measured on pieces of the polymer produced above and were found to have a surface resistivity at the radius of 30 Ohms per square and a surface resistivity at the fracture of 24 Ohms per square.

### Example 39

To a 250 milliliter glass flask was added dimethyl terephthalate, (91.91 grams), 1,3-propanediol, (46.82 grams), Ketjenblack® EC 600 JD, (0.50 grams), Ketjenblack® EC 300 J, (2.00 grams), and titanium(IV) isopropoxide, (0.1188 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 190° C. over 0.3 hours while under a slow nitrogen purge. After achieving 190° C., the resulting reaction mixture was stirred at 190° C. for 0.7 hours is while under a slow nitrogen purge. The reaction mixture was then stirred and heated to 200° C. over 0.2 hours while under a slow nitrogen purge. After achieving 200° C., the resulting reaction mixture was stirred at 200° C. for 0.6 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.5 hours while under a slow nitrogen purge. The reaction mixture was heated to 255° C. over 0.4 hours with stirring under a slow nitrogen purge. The resulting reaction mixture was stirred at 255° C. under a slight nitrogen purge for 0.6 hours. 21.39 grams of a colorless distillate was collected over this heating cycle. The reaction mixture was then staged to full vacuum with stirring at 255° C. The resulting reaction mixture was stirred for 1.7 hours under full vacuum, (pressure less than 100 mtorr). The vacuum was then released with nitrogen and the reaction mass allowed to cool to room temperature. An additional 6.10 grams of distillate was recovered and 93.7 grams of a solid product was recovered.

The sample was measured for laboratory relative viscosity, (LRV), as described above and was found to have an LRV of 36.08. This sample was calculated to have an inherent viscosity of 0.90 dL/g.

The sample underwent differential scanning calorimetry, (DSC), analysis. A recrystallization temperature was found on the programmed cool after the first heat cycle with an onset at 187.3° C. and a peak at 178.9° C., (55.2 J/g). A crystalline melting temperature, (Tm), was observed at 230.8° C., (50.3 J/g).

### Example 40

To a 250 milliliter glass flask was added dimethyl terephthalate, (86.50 grams), 1,4-butanediol, (52.22 grams), Ketjenblack® EC 600 JD, (1.00 grams), Ketjenblack® EC 300 J, (1.00 grams), and titanium(IV) isopropoxide, (0.123 grams). The reaction mixture was stirred and heated to 180° C. under a slow nitrogen purge. After achieving 180° C., the resulting reaction mixture was stirred at 180 C for 0.5 hours while under a slow nitrogen purge. The reaction mixture was then stirred and heated to 190° C. over 0.1 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.1 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.7 hours while under a slow nitrogen purge. The reaction mixture was heated to 255° C. over 0.3 hours with stirring under a slow nitrogen purge. The resulting reaction mixture was stirred at 255° C. under a slight nitrogen purge for 1.3 hours. 16.51 grams of a colorless distillate was collected over this heating cycle. The reaction mixture was then staged to full vacuum with stirring at 255° C. The resulting reaction mixture was stirred for 0.8 hours under full vacuum, (pressure less than 100 mtorr). The vacuum was then released with nitrogen and the reaction mass allowed to cool to room temperature. An additional 4.34 grams of distillate was recovered and 92.8 grams of a solid product was recovered.

The sample was measured for laboratory relative viscosity, (LRV), as described above and was found to have an LRV of 37.95. This sample was calculated to have an inherent viscosity of 0.93 dL/g.

The sample underwent differential scanning calorimetry, (DSC), analysis. A recrystallization temperature was found on the programmed cool after the first heat cycle with an onset at 198.2° C. and a peak at 194.5° C., (51.1 J/g). A crystalline melting temperature, (Tm), was observed at 226.9° C., (49.1 J/g).

### Example 41

To a 500 milliliter glass flask was added bis(2-hydroxyethyl)terephthalate, (314.49 grams), Vulcan® XC72, (8.75 grams), Ketjenblack® EC 600 JD, (3.75 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.8 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.6 hours while under a slow nitrogen purge. The reaction mixture was heated to 295° C. over 1.1 hours with stirring under a slow nitrogen purge. The resulting reaction mixture was stirred at 295° C. under a slight nitrogen purge for 0.7 hours. 52.14 grams of a colorless distillate was collected over this heating cycle. The reaction mixture was then staged to full vacuum with stirring at 295° C. The resulting reaction mixture was stirred for 4.2 hours under full vacuum, (pressure less than 100 mtorr). The vacuum was then released with nitrogen and the reaction mass allowed to cool to room temperature. An additional 21.60 grams of distillate was recovered and 235.5 grams of a solid product was recovered.

The sample was measured for laboratory relative viscosity, (LRV), as described above and was found to have an LRV of 14.03. This sample was calculated to have an inherent viscosity of 0.50 dL/g.

The sample underwent differential scanning calorimetry, (DSC), analysis. A recrystallization temperature was found on the programmed cool after the first heat cycle with an onset at 211.7° C. and a peak at 207.1° C., (45.7 J/g). A glass transition temperature, (Tg), was found with an onset temperature of 77.6° C., a midpoint temperature of 81.6° C., and an endpoint temperature of 85.3° C. A crystalline melting temperature, (Tm), was observed at 250.6° C., (47.2 J/g).

### Example 42

To a 250 milliliter glass flask was added dimethyl terephthalate, (87.21 grams), ethylene glycol, (29.89 grams), 1,4-cyclohexanedimethanol, (20.60 grams), Ketjenblack® EC 600 JD, (2.00 grams), a ball milled dispersion of 1.5 weight percent Ketjenblack® EC 300 J in ethylene glycol, (33.33 grams, provided as Aquablak® 6072 from the Solutions Dispersion Company), manganese(II) acetate tetrahydrate, (0.0446 grams), and antimony(III) trioxide, (0.0359 grams). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 190° C. over 0.2 hours while under a slow nitrogen purge. After achieving 190° C., the resulting reaction mixture was stirred at 190° C. for 0.5 hours while under a slow nitrogen purge. The reaction mixture was then stirred and heated to 200° C. over 0.3 hours while under a slow nitrogen purge. After achieving 200° C., the resulting reaction mixture was stirred at 200° C. for 0.5 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.5 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.6 hours. 56.21 grams of a colorless distillate was collected over this heating cycle. The reaction mixture was then staged to full vacuum with stirring at 295° C. The resulting reaction mixture was stirred for 2.4 hours under full vacuum, (pressure less than 100 mtorr). The vacuum was then released with nitrogen and the reaction mass allowed to cool to room temperature. An additional 7.00 grams of distillate was recovered and 93.3 grams of a solid product was recovered.

The sample was measured for laboratory relative viscosity, (LRV), as described above and was found to have an LRV of 19.87. This sample was calculated to have an inherent viscosity of 0.61 dL/g.

The sample underwent differential scanning calorimetry, (DSC), analysis. A glass transition temperature, (Tg), was found with an onset temperature of 75.0° C., a midpoint temperature of 77.1° C., and an endpoint temperature of 79.2° C. A broad crystalline melting temperature, (Tm), was observed at a temperature of 166.5° C., (0.5 J/g).

### Example 43

To a 500 milliliter glass flask was added bis(2-hydroxyethyl)terephthalate, (314.49 grams), Vulcan® XC72, (7.50 grams), Ketjenblack® EC 600 JD, (5.00 grams), manganese(II) acetate tetrahydrate, (0.1115 grams), and antimony(III) trioxide, (0.0908 grams). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 225° C. over 0.5 hours while under a slow nitrogen purge. After achieving 225° C., the resulting reaction mixture was stirred at 225° C. for 1.2 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.6 hours. 42.53 grams of a colorless distillate was collected over this heating cycle. The reaction mixture was then staged to full vacuum with stirring at 295° C. The resulting reaction mixture was stirred for 0.9 hours under full vacuum, (pressure less than 100 mtorr). The vacuum was then released with nitrogen and the reaction mass allowed to cool to room temperature. An additional 26.11 grams of distillate was recovered and 244.9 grams of a solid product was recovered.

The sample was measured for laboratory relative viscosity, (LRV), as described above and was found to have an LRV of 19.12. This sample was calculated to have an inherent viscosity of 0.59 dL/g.

The sample underwent differential scanning calorimetry, (DSC), analysis. A recrystallization temperature was found on the programmed cool after the first heat cycle with an onset at 213.5° C. and a peak at 209.1° C., (41.6 J/g). A glass transition temperature, (Tg), was found with an onset temperature of 75.3° C., a midpoint temperature of 80.6° C., and an endpoint temperature of 85.9° C. A crystalline melting temperature, (Tm), was observed at 253.1° C., (42.4 J/g).

Surface resistivity was measured on pieces of the polymer produced above and were found to have a surface resistivity at the radius of 73 Ohms per square and a surface resistivity at the fracture of 79 Ohms per square.

### Example 44

To a 500 milliliter glass flask was added bis(2-hydroxyethyl)terephthalate, (306.21 grams), Vulcan® XC72, (12.50 grams), Ketjenblack® EC 600 JD, (6.25 grams), manganese(II) acetate tetrahydrate, (0.1115 grams), and antimony(III) trioxide, (0.0898 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 295° C. over 0.8 hours with stirring under a slow nitrogen purge. The resulting reaction mixture was stirred at 295° C. under a slight nitrogen purge for 0.6 hours. 41.33 grams of a colorless distillate was collected over this heating cycle. The reaction mixture was then staged to full vacuum with stirring at 295° C. The resulting reaction mixture was stirred for 4.0 hours under full vacuum, (pressure less than 100 mtorr). The vacuum was then released with nitrogen and the reaction mass allowed to cool to room temperature. An additional 31.70 grams of distillate was recovered and 238.8 grams of a solid product was recovered.

The sample was not found to completely dissolve in the laboratory relative viscosity, (LRV), solvent system.

The sample underwent differential scanning calorimetry, (DSC), analysis. A recrystallization temperature was found on the programmed cool after the first heat cycle with an onset at 214.4° C. and a peak at 208.8° C., (47.4 J/g). A glass transition temperature, (Tg), was found with an onset temperature of 73.5° C., a midpoint temperature of 76.3° C., and an endpoint temperature of 79.6° C. A crystalline melting temperature, (Tm), was observed at 251.4° C., (42.8 J/g).

Surface resistivity was measured on pieces of the polymer produced above and were found to have a surface resistivity at the radius of 33 Ohms per square and a surface resistivity at the fracture of 33 Ohms per square.

### Example 45

To a 250 milliliter glass flask was added bis(2-hydroxyethyl)terephthalate, (125.80 grams), ethylene glycol, (25.00 grams), Printex® XE-2, (5.00 grams), manganese(II) acetate tetrahydrate, (0.0447 grams), and antimony(III) trioxide, (0.0361 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.7 hours while under a slow nitrogen purge. The reaction mixture was heated to 295° C. over 0.4 hours with stirring under a slow nitrogen purge. The resulting reaction mixture was stirred at 295° C. under a slight nitrogen purge for 0.7 hours. 37.65 grams of a colorless distillate was collected over this heating cycle. The reaction mixture was then staged to full vacuum with stirring at 295° C. The resulting reaction mixture was stirred for 1.4 hours under full vacuum, (pressure less than 100 mtorr). The vacuum was then released with nitrogen and the reaction mass allowed to cool to room temperature. An additional 14.66 grams of distillate was recovered and 88.7 grams of a solid product was recovered.

The sample was measured for laboratory relative viscosity, (LRV), as described above and was found to have an LRV of 15.50. This sample was calculated to have an inherent viscosity of 0.53 dL/g.

The sample underwent differential scanning calorimetry, (DSC), analysis. A recrystallization temperature was found on the programmed cool after the first heat cycle with an onset at 213.5° C. and a peak at 209.0° C., (40.4 J/g). A glass transition temperature, (Tg), was found with an onset temperature of 69.1° C., a midpoint temperature of 75.3° C., and an endpoint temperature of 81.6° C. A crystalline melting temperature, (Tm), was observed at 247.3° C., (40.1 J/g).

### Example 46

To a 250 milliliter glass flask was added bis(2-hydroxyethyl)terephthalate, (124.47 grams), ethylene glycol, (25.00 grams), Printex® XE-2, (5.00 grams), manganese(II) acetate tetrahydrate, (0.0446 grams), antimony(III) trioxide, (0.0359 grams), and paraffin oil, (1.00 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.6 hours while under a slow nitrogen purge. The reaction mixture was heated to 295° C. over 1.0 hour with stirring under a slow nitrogen purge. The resulting reaction mixture was stirred at 295° C. under a slight nitrogen purge for 0.5 hours. 44.69 grams of a colorless distillate was collected over this heating cycle. The reaction mixture was then staged to full vacuum with stirring at 295° C. The resulting reaction mixture was stirred for 3.9 hours under full vacuum, (pressure less than 100 mtorr). The vacuum was then released with nitrogen and the reaction mass allowed to cool to room temperature. An additional 9.20 grams of distillate was recovered and 90.1 grams of a solid product was recovered.

The sample was measured for laboratory relative viscosity, (LRV), as described above and was found to have an LRV of 20.19. This sample was calculated to have an inherent viscosity of 0.61 dL/g.

The sample underwent differential scanning calorimetry, (DSC), analysis. A recrystallization temperature was found on the programmed cool after the first heat cycle with an onset at 210.7° C. and a peak at 205.1° C., (44.1 J/g). A glass transition temperature, (Tg), was found with an onset temperature of 79.2° C., a midpoint temperature of 79.9° C., and an endpoint temperature of 81.2° C. A crystalline melting temperature, (Tm), was observed at 247.1° C., (42.9 J/g).

### Example 47

To a 250 milliliter glass flask was added bis(2-hydroxyethyl)terephthalate, (121.82 grams), ethylene glycol, (25.00 grams), Printex® XE-2, (5.00 grams), manganese(II) acetate tetrahydrate, (0.0443 grams), antimony(III) trioxide, (0.0365 grams), and paraffin oil, (3.00 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 1.0 hour while under a slow nitrogen purge. The reaction mixture was heated to 295° C. over 0.6 hours with stirring under a slow nitrogen purge. The resulting reaction mixture was stirred at 295° C. under a slight nitrogen purge for 0.6 hours. 41.31 grams of a colorless distillate was collected over this heating cycle. The reaction mixture was then staged to full vacuum with stirring at 295° C. The resulting reaction mixture was stirred for 0.8 hours under full vacuum, (pressure less than 100 mtorr). The vacuum was then released with nitrogen and the reaction mass allowed to cool to room temperature. An additional 13.87 grams of distillate was recovered and 80.8 grams of a solid product was recovered.

The sample was measured for laboratory relative viscosity, (LRV), as described above and was found to have an LRV of 22.09. This sample was calculated to have an inherent viscosity of 0.65 dL/g.

The sample underwent differential scanning calorimetry, (DSC), analysis. A recrystallization temperature was found on the programmed cool after the first heat cycle with an onset at 211.8° C. and a peak at 206.0° C., (33.4 J/g). A glass transition temperature, (Tg), was found with an onset temperature of 74.5° C., a midpoint temperature of 79.7 C, and an endpoint temperature of 84.9 C. A crystalline melting temperature, (Tm), was observed at 249.6° C., (36.1 J/g).

### Example 48

To a 250 milliliter glass flask was added bis(2-hydroxyethyl)terephthalate, (122.36 grams), ethylene glycol, (25.01 grams), Printex® XE-2, (5.01 grams), manganese(II) acetate tetrahydrate, (0.0451 grams), antimony(III) trioxide, (0.0365 grams), and paraffin oil, (2.98 grams). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.7 hours while under a slow nitrogen purge. The reaction mixture was heated to 295° C. over 0.6 hours with stirring under a slow nitrogen purge. The resulting reaction mixture was stirred at 295° C. under a slight nitrogen purge for 0.7 hours. 39.48 grams of a colorless distillate was collected over this heating cycle. The reaction mixture was then staged to full vacuum with stirring at 295° C. The resulting reaction mixture was stirred for 1.4 hours under full vacuum, (pressure less than 100 mtorr). The vacuum was then released with nitrogen and the reaction mass allowed to cool to room temperature. An additional 16.76 grams of distillate was recovered and 82.9 grams of a solid product was recovered.

The sample was measured for laboratory relative viscosity, (LRV), as described above and was found to have an LRV of 23.21. This sample was calculated to have an inherent viscosity of 0.67 dL/g.

The sample underwent differential scanning calorimetry, (DSC), analysis. A recrystallization temperature was found on the programmed cool after the first heat cycle with an onset at 215.3° C. and a peak at 210.2° C., (40.8 J/g). A glass transition temperature, (Tg), was found with an onset temperature of 73.5° C., a midpoint temperature of 79.3° C., and an endpoint temperature of 85.2° C. A crystalline melting temperature, (Tm), was observed at 251.1° C., (39.6 J/g).

### Example 49

To a 250 milliliter glass flask was added bis(2-hydroxyethyl)terephthalate, (121.82 grams), ethylene glycol, (25.00 grams), Printex® XE-2, (5.00 grams), manganese(II) acetate tetrahydrate, (0.0446 grams), antimony(III) trioxide, (0.0359 grams), and poly(ethylene), (3.00 grams, average molecular weight=4,000, average Mn=1700, viscosity=1.5 poise). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.6 hours while under a slow nitrogen purge. After achieving 225° C., the resulting reaction mixture was stirred at 225° C. for 0.6 hours while under a slow nitrogen purge. The reaction mixture was heated to 295° C. over 0.9 hours with stirring under a slow nitrogen purge. The resulting reaction mixture was stirred at 295° C. under a slight nitrogen purge for 0.5 hours. 42.82 grams of a colorless distillate was collected over this heating cycle. The reaction mixture was then staged to full vacuum with stirring at 295° C. The resulting reaction mixture was stirred for 3.6 hours under full vacuum, (pressure less than 100 mtorr). The vacuum was then released with nitrogen and the reaction mass allowed to cool to room temperature. An additional 11.70 grams of distillate was recovered and 89.9 grams of a solid product was recovered.

The sample was measured for laboratory relative viscosity, (LRV), as described above and was found to have an LRV of 15.28. This sample was calculated to have an inherent viscosity of 0.52 dL/g.

The sample underwent differential scanning calorimetry, (DSC), analysis. A recrystallization temperature was found on the programmed cool after the first heat cycle with an onset at 211.1° C. and a peak at 205.7° C., (40.5 J/g). A glass transition temperature, (Tg), was found with an onset temperature of 79.4° C., a midpoint temperature of 80.3° C., and an endpoint temperature of 81.0° C. A crystalline melting temperature, (Tm), was observed at 246.5° C., (40.8 J/g).

### Example 50

To a 250 milliliter glass flask was added bis(2-hydroxyethyl)terephthalate, (121.82 grams), ethylene glycol, (25.00 grams), Printex® XE-2, (5.00 grams), manganese(II) acetate tetrahydrate, (0.0443 grams), antimony(III) trioxide, (0.0365 grams), and Poly(ethylene glycol)distearate, (3.00 grams, Average Mn ca. 930). The reaction mixture was stirred and heated to 180° C. under a slow nitrogen purge. After achieving 180° C., the resulting reaction mixture was stirred at 180° C. for 0.7 hours while under a slow nitrogen purge. The reaction mixture was then stirred and heated to 225° C. over 0.2 hours while under a slow nitrogen purge. After achieving 225° C., the resulting reaction mixture was stirred at 225° C. for 0.5 hours while under a slow nitrogen purge. The reaction mixture was heated to 295° C. over 0.4 hour with stirring under a slow nitrogen purge. The resulting reaction mixture was stirred at 295° C. under a slight nitrogen purge for 0.6 hours. 43.41 grams of a colorless distillate was collected over this heating cycle. The reaction mixture was then staged to full vacuum with stirring at 295° C. The resulting reaction mixture was stirred for 1.8 hours under full vacuum, (pressure less than 100 mtorr). The vacuum was then released with nitrogen and the reaction mass allowed to cool to room temperature. An additional 10.15 grams of distillate was recovered and 84.6 grams of a solid product was recovered.

The sample was measured for laboratory relative viscosity, (LRV), as described above and was found to have an LRV of 21.54. This sample was calculated to have an inherent viscosity of 0.63 dL/g.

The sample underwent differential scanning calorimetry, (DSC), analysis. A recrystallization temperature was found on the programmed cool after the first heat cycle with an onset at 212.2° C. and a peak at 207.1° C., (38.4 J/g). A glass transition temperature, (Tg), was found with an onset temperature of 59.8° C., a midpoint temperature of 67.9° C., and an endpoint temperature of 76.0° C. A crystalline melting temperature, (Tm), was observed at 247.4° C., (39.7 J/g).

### Example 51

To a 250 milliliter glass flask was added bis(2-hydroxyethyl)terephthalate, (121.82 grams), ethylene glycol, (25.00 grams), Printex® XE-2, (5.00 grams), manganese(II) acetate tetrahydrate, (0.0443 grams), antimony(III) trioxide, (0.0365 grams), and poly(dimethylsiloxane), (3.00 grams, viscosity=10 ct). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.2 hours while under a slow nitrogen purge. After achieving 225° C., the resulting reaction mixture was stirred at 225° C. for 1.2 hours while under a slow nitrogen purge. The reaction mixture was heated to 295° C. over 0.7 hours with stirring under a slow nitrogen purge. The resulting reaction mixture was stirred at 295° C. under a slight nitrogen purge for 0.7 hours. 41.28 grams of a colorless distillate was collected over this heating cycle. The reaction mixture was then staged to full vacuum with stirring at 295° C. The resulting reaction mixture was stirred for 1.1 hours under full vacuum, (pressure less than 100 mtorr). The vacuum was then released with nitrogen and the reaction mass allowed to cool to room temperature. An additional 14.02 grams of distillate was recovered and 86.8 grams of a solid product was recovered.

The sample was measured for laboratory relative viscosity, (LRV), as described above and was found to have an LRV of 17.96. This sample was calculated to have an inherent viscosity of 0.57 dL/g.

The sample underwent differential scanning calorimetry, (DSC), analysis. A recrystallization temperature was found on the programmed cool after the first heat cycle with an onset at 212.8° C. and a peak at 207.3° C., (39.3 J/g). A glass transition temperature, (Tg), was found with an onset temperature of 71.7° C., a midpoint temperature of 78.7° C., and an endpoint temperature of 85.5° C. A crystalline melting temperature, (Tm), was observed at 247.7° C., (39.8 J/g).

### Example 52

To a 250 milliliter glass flask was added bis(2-hydroxyethyl)terephthalate, (121.82 grams), ethylene glycol, (25.00 grams), Printex® XE-2, (5.00 grams), manganese(II) acetate tetrahydrate, (0.0446 grams), antimony(III) trioxide, (0.0359 grams), and soybean oil, (3.00 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.5 hours while under a slow nitrogen purge. The reaction mixture was heated to 295° C. over 0.8 hours with stirring under a slow nitrogen purge. The resulting reaction mixture was stirred at 295 C under a slight nitrogen purge for 0.7 hours. 39.42 grams of a colorless distillate was collected over this heating cycle. The reaction mixture was then staged to full vacuum with stirring at 295° C. The resulting reaction mixture was stirred for 1.7 hours under full vacuum, (pressure less than 100 mtorr). The vacuum was then released with nitrogen and the reaction mass allowed to cool to room temperature. An additional 10.70 grams of distillate was recovered and 77.3 grams of a solid product was recovered.

The sample was not completely soluble within the laboratory relative viscosity, (LRV), solvent, as described above.

The sample underwent differential scanning calorimetry, (DSC), analysis. A recrystallization temperature was found on the programmed cool after the first heat cycle with an onset at 208.8° C. and a peak at 202.9° C., (39.8 J/g). A glass transition temperature, (Tg), was found with an onset temperature of 69.4° C., a midpoint temperature of 69.9° C., and an endpoint temperature of 71.1° C. A crystalline melting temperature, (Tm), was observed at 244.1° C., (38.7 J/g).

### Example 53

To a 250 milliliter glass flask was added bis(2-hydroxyethyl)terephthalate, (132.35 grams), Printex® XE-2, (0.05 grams), manganese(II) acetate tetrahydrate, (0.0445 grams), and antimony(III) trioxide, (0.0357 grams). The reaction mixture was stirred and heated to 180° C. under a slow nitrogen purge. After achieving 180 C, the resulting reaction mixture was stirred at 180° C. for 0.8 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.5 hours while under a slow nitrogen purge. The reaction mixture was heated to 285° C. over 0.7 hours with stirring under a slow nitrogen purge. The resulting reaction mixture was stirred at 285° C. under a slight nitrogen purge for 1.2 hours. 15.08 grams of a colorless distillate was collected over this heating cycle. The reaction mixture was then staged to full vacuum with stirring at 285° C. The resulting reaction mixture was stirred for 4.3 hours under full vacuum, (pressure less than 100 mtorr). The vacuum was then released with nitrogen and the reaction mass allowed to cool to room temperature. An additional 16.03 grams of distillate was recovered.

The sample was measured for laboratory relative viscosity, (LRV), as described above and was found to have an LRV of 12.08. This sample was calculated to have an inherent viscosity of 0.46 dL/g.

The sample underwent differential scanning calorimetry, (DSC), analysis. A recrystallization temperature was found on the programmed cool after the first heat cycle with an onset at 215.4° C. and a peak at 211.6° C., (51.6 J/g). A glass transition temperature, (Tg), was found with an onset temperature of 71.4° C., a midpoint temperature of 77.1° C., and an endpoint temperature of 82.8° C. A crystalline melting temperature, (Tm), was observed at 249.6° C., (48.7 J/g).

### Example 54

To a 250 milliliter glass flask was added bis(2-hydroxyethyl)terephthalate, (132.28 grams), Printex® XE-2, (0.10 grams), manganese(II) acetate tetrahydrate, (0.0457 grams), and antimony(III) trioxide, (0.0356 grams). The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred and heated to 225° C. over 0.3 hours while under a slow nitrogen purge. After achieving 225° C., the resulting reaction mixture was stirred at 225° C. for 0.6 hours while under a slow nitrogen purge. The reaction mixture was heated to 285° C. over 0.3 hours with stirring under a slow nitrogen purge. The resulting reaction mixture was stirred at 285° C. under a slight nitrogen purge for 1.3 hours. 19.47 grams of a colorless distillate was collected over this heating cycle. The reaction mixture was then staged to full vacuum with stirring at 285° C. The resulting reaction mixture was stirred for 1.3 hours under full vacuum, (pressure less than 100 mtorr). The vacuum was then released with nitrogen and the reaction mass allowed to cool to room temperature. An additional 12.81 grams of distillate was recovered and 76.0 grams of a solid product was recovered.

The sample was measured for laboratory relative viscosity, (LRV), as described above and was found to have an LRV of 26.27. This sample was calculated to have an inherent viscosity of 0.72 dL/g.

The sample underwent differential scanning calorimetry, (DSC), analysis. A recrystallization temperature was found on the programmed cool after the first heat cycle with an onset at 211.5° C. and a peak at 206.8° C., (43.1 J/g). A glass transition temperature, (Tg), was found with an onset temperature of 74.1° C., a midpoint temperature of 79.7° C., and an endpoint temperature of 85.0° C. A crystalline melting temperature, (Tm), was observed at 248.9° C., (43.6 J/g).

### Example 55

To a 250 milliliter glass flask was added bis(2-hydroxyethyl)terephthalate, (132.09 grams), Printex® XE-2, (0.255 grams), manganese(II) acetate tetrahydrate, (0.0455 grams), and antimony(III) trioxide, (0.0366 grams). The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was then stirred and heated to 225° C. over 0.4 hours while under a slow nitrogen purge. After achieving 225° C., the resulting reaction mixture was stirred at 225° C. for 0.6 hours while under a slow nitrogen purge. The reaction mixture was heated to 285° C. over 0.5 hours with stirring under a slow nitrogen purge. The resulting reaction mixture was stirred at 285° C. under a slight nitrogen purge for 1.2 hours. 17.82 grams of a colorless distillate was collected over this heating cycle. The reaction mixture was then staged to full vacuum with stirring at 285° C. The resulting reaction mixture was stirred for 0.9 hours under full vacuum, (pressure less than 100 mtorr). The vacuum was then released with nitrogen and the reaction mass allowed to cool to room temperature. An additional 14.40 grams of distillate was recovered and 90.0 grams of a solid product was recovered.

The sample was measured for laboratory relative viscosity, (LRV), as described above and was found to have an LRV of 22.64. This sample was calculated to have an inherent viscosity of 0.66 dL/g.

The sample underwent differential scanning calorimetry, (DSC), analysis. A recrystallization temperature was found on the programmed cool after the first heat cycle with an onset at 214.21° C. and a peak at 210.3° C., (44.7 J/g). A glass transition temperature, (Tg), was found with an onset temperature of 73.9° C., a midpoint temperature of 81.2 C, and an endpoint temperature of 88.5 C. A crystalline melting temperature, (Tm), was observed at 252.2° C., (46.9 J/g).

### Example 56

To a 250 milliliter glass flask was added bis(2-hydroxyethyl)terephthalate, (131.75 grams), Printex® XE-2, (0.50 grams), manganese(II) acetate tetrahydrate, (0.0451 grams), and antimony(III) trioxide, (0.0355 grams). The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred and heated to 225° C. over 0.5 hours while under a slow nitrogen purge. After achieving 225° C., the resulting reaction mixture was stirred at 225° C. for 0.6 hours while under a slow nitrogen purge. The reaction mixture was heated to 285° C. over 0.4 hours with stirring under a slow nitrogen purge. The resulting reaction mixture was stirred at 285° C. under a slight nitrogen purge for 1.0 hour. 18.25 grams of a colorless distillate was collected over this heating cycle. The reaction mixture was then staged to full vacuum with stirring at 285° C. The resulting reaction mixture was stirred for 0.9 hours under full vacuum, (pressure less than 100 mtorr). The vacuum was then released with nitrogen and the reaction mass allowed to cool to room temperature. An additional 13.70 grams of distillate was recovered and 92.0 grams of a solid product was recovered.

The sample was measured for laboratory relative viscosity, (LRV), as described above and was found to have an LRV of 20.67. This sample was calculated to have an inherent viscosity of 0.62 dL/g.

The sample underwent differential scanning calorimetry, (DSC), analysis. A recrystallization temperature was found on the programmed cool after the first heat cycle with an onset at 213.2° C. and a peak at 209.0° C., (42.9 J/g). A glass transition temperature, (Tg), was found with an onset temperature of 75.5° C., a midpoint temperature of 80.2° C., and an endpoint temperature of 85.0° C. A crystalline melting temperature, (Tm), was observed at 250.1° C., (39.6 J/g).

1. A method comprising contacting a first composition with a second composition under a condition effective to produce a polyester and optionally recovering the polyester wherein
the first composition comprises at least one dicarboxylic acid, at least one oligomer of the acid, or both;
the second composition comprises at least one glycol;
the first composition, the second composition, or both optionally comprises at least one carbon black and optionally an additive including filler or blend of polymers;
the mole ratio of glycol to dicarboxylic acid ranges from about 0.9:1 to about 1.1:1;
the carbon black is present in less than 15 weight % of the total weight of the polyester and the carbon black or less than 9 weight % of the total weight of the dicarboxylic acid, glycol, and carbon black;
the carbon black has a dibutyl phthalate oil adsorption either greater than 420 cc/100 g, between 220 cc/100 g and 420 cc/100 g, between 150 cc/100 g and 210 cc/100 g, or combinations of two or more thereof wherein the dibutyl phthalate oil adsorption is determined by ASTM D2414-93.

2. A method according to claim 1 wherein the carbon black is present from 0.5 to 4.5% of the total weight of the dicarboxylic acid, glycol, and carbon black and has the dibutyl phthalate oil adsorption greater than 420 cc/100 g.

3. A method according to claim 2 wherein the carbon black is present from 1 to 3.5% of the total weight of the dicarboxylic acid, glycol, and carbon black.

4. A method according to claim 1 the carbon black is present from 0.5 to 9% of the total weight of the dicarboxylic acid, glycol, and carbon black and has the dibutyl phthalate oil adsorption between 220 cc/100 g and 420 cc/100 g.

5. A method according to claim 4 wherein the carbon black is present from 2 to 7.5% of the total weight of the dicarboxylic acid, glycol, and carbon black.

6. A method according to claim 4 wherein the carbon black is present from 2.5 to 6% of the total weight of the dicarboxylic acid, glycol, and carbon black.

7. A method according to claim 1 wherein the carbon black is present from 4 to 15% of the total weight of the polyester and carbon black and has the dibutyl phthalate oil adsorption between 150 cc/100 g and 210 cc/100 g.

8. A method according to claim 7 wherein the carbon black is present from 5 to 12.5% of the total weight of the polyester and carbon black.

9. A method according to claim 7 wherein the carbon black is present from 6 to 10% of the total weight of the polyester and carbon black.

10. A method according to claim 1 wherein the first composition or second composition or both comprises at least two carbon blacks and optionally a third carbon black; the first carbon black is present form 0.1 to 4.5% and has the dibutyl phthalate oil adsorption greater than 420 cc/100 g; the second carbon black is present from 0.5 to 9% and has the dibutyl phthalate oil adsorption between 220 cc/100 g and 420 cc/100 g; the third carbon black is present from 1 to 12.5% and carbon black and has the dibutyl phthalate oil adsorption between 150 cc/100 g and 210 cc/100 g; and all % is of the total weight of the polyester and carbon black.

11. A method of claim 10 wherein the first carbon black is present from 0.5 to 3.5% and the second carbon black is present from 1 to 6%.

12. A method according to claim 11 wherein the first composition, second composition, or both further comprises the third carbon black from 2 to 7.5% of the total weight of the polyester and carbon black.

13. A method according to claim 10 wherein the total weight percent of carbon blacks is from 1 to 15%.

14. A method according to claim 11 wherein the total weight percent of carbon blacks is from 1.5 to 12.5%.

15. A method according to claim 12 wherein the total weight percent of carbon blacks is from 2 to 10%.

16. A method according to claim 6 wherein the carbon black is deagglomerated.

17. A method according to claim 9 wherein the carbon black is deagglomerated.

18. A method according to claim 13 wherein at least one carbon black is deagglomerated.

19. A method according to claim 15 wherein at least one carbon black is deagglomerated.

20. An antistatic, static dissipating or conductive polyester composition produced according to a method wherein the method is recited in claim 1.

21. A composition according to claim 20 wherein the method is as recited in claim 4.

22. A composition according to claim 20 wherein the method is as recited in claim 7.

23. A composition according to claim 20 wherein the method is as recited in claim 10.

24. A composition according to claim 20 wherein the method is as recited in claim 13.

25. A shaped article produced from a composition is selected from the group consisting of the composition recited in claim 21, 22, 23, 24, or combinations of two or more thereof wherein the composition optionally comprises at least one thermal stabilizer, UV stabilizer, filler, or blend of polymers and the filler includes glass fiber or wollastonite.

26. A shaped article according to claim 25 being monofilament, fiber, textile, film, sheet, molded part, foam, polymeric melt extrusion coating onto substrate, polymeric solution coating onto substrate, laminate, container, blown bottle, or combinations of two or more thereof.

27. A shaped article according to claim 26 wherein the composition is as recited in claim 21.

28. A shaped article according to claim 26 wherein the composition is recited in claim 22.

29. A shaped article according to claim 26 wherein the composition is recited in claim 24.
